(19) United States
(12) Patent Application Publication
(10) Pub. No.: US 2013/0066869 A1
(43) Pub. Date: Mar. 14, 2013

(54) COMPUTER SYSTEM, METHOD OF MANAGING A CLIENT COMPUTER, AND STORAGE MEDIUM

(71) Applicants: Yusuke Kusaka, Yokohama (JP); Tomotada Naito, Yokohama (JP)

(72) Inventors: Yusuke Kusaka, Yokohama (JP); Tomotada Naito, Yokohama (JP)

(21) Appl. No.: 13/380,738

(22) PCT Filed: Sep. 13, 2011
(86) PCT No.: PCT/JP2011/070799

§ 371 Date: Dec. 23, 2011

(51) Int. Cl. G06F 17/30

(52) U.S. Cl. 707/737; 707/E17.046

(57) ABSTRACT

In an embodiment, a client acquires an operation log of operations in the client. A management system acquires a first operation log group consisting of operation log records including an operation log record of an operation in which a first problem is generated from the operation log. The management system stores in advance problem examples associated with operation log groups each consisting of operation log records and with solutions. The management system searches the operation log groups associated with the stored problem examples for an operation log group determined to be similar to the first operation log group based on the operation log records of the first operation log group. The management system determines a solution to one of the problem examples that is associated with the operation log group determined to be similar to the first operation log group, as a solution candidate to the first problem.

### BACKGROUND

This invention relates to managing a client computer, and more particularly, to managing a client computer by using an operation log in the client computer.

In a computer system in which a client computer used by a user and a server computer are communicably connected by a network, there is a need to collect a log generated by the client computer and keep track of a history of various operations on the client computer based on the collected log. For example, WO 2010/112960 A1 (Patent Literature 1) discloses a technology of determining a configuration change that caused an invocation failure of an application program without the need for a knowledge database.

There has been widely provided a help desk service in which, when a problem is generated in the client computer, an operator solves the problem. Typically, the user reports the problem generated in the client computer used by the user to a help desk by E-mail or telephone. An operator at the help desk presents a method of solving the reported problem by E-mail, telephone, or remote operations of the client computer.

Incidentally, in recent years, there is an increasing need for keeping track of the task proceeding of a user against the background of improving the task efficiency and increasing compliance. To give an example, there is a need to monitor the task proceeding of a user through operations on the client computer by the user.

In order to quickly present a solution to the problem in the client computer, it is desired for a management system to receive the report of the problem and automatically present the solution to the client computer, rather than addressing the problem by an operator. However, for that purpose, the management system needs to be able to analyze the generated problem and present an appropriate solution to the problem.

Incidentally, to keep track of the task proceeding of a user, there is a need to collect and analyze an operation log (log events that have occurred from user operation) of the client computer used by the user. In order to reduce the burden on the administrator, it is desired for the management system to analyze the operation log of the user and estimate the task proceeding of the user more correctly.

Patent Literature 1: WO 2010/112960 A1

### SUMMARY

An aspect of the invention is a computer system comprising a client computer and a management system. The client computer acquires an operation log of operations in the client computer. The management system acquires a first operation log group consisting of a plurality of operation log records including an operation log record of an operation in which a first problem is generated from the operation log. The management system stores in advance problem examples associated with operation log groups each consisting of a plurality of operation log records and with solutions. The management system searches the operation log groups associated with the stored problem examples for an operation log group which is determined to be similar to the first operation log group based on the plurality of operation log records of the first operation log group. The management system determines a solution to one of the problem examples that is associated with the operation log group determined to be similar to the first operation log group, as a solution candidate to the first problem.

According to an aspect of the invention, the client computer may be appropriately managed by using the operation log in the client computer.

### BRIEF DESCRIPTION OF THE DRAWINGS

In the accompanying drawings:

FIG. 1 schematically illustrates an example configuration of a computer system including a client computer and a management server for the client computer according to an embodiment of this invention;

FIG. 2 schematically illustrates an example configuration of the management server according to the embodiment of this invention;

FIG. 3A illustrates a part of an example of an operation log DB according to the embodiment of this invention;

FIG. 3B illustrates another part of the example of the operation log DB according to the embodiment of this invention;

FIG. 4 illustrates an example of an association definition table according to the embodiment of this invention;

FIG. 5 illustrates an example of an inquiry screen for a problem in the client computer according to the embodiment of this invention;

FIG. 6 is a flow chart illustrating processing for, in response to an inquiry about a problem generated in the client computer, acquiring information required by the management server to analyze the problem according to the embodiment of this invention;

FIG. 7 illustrates an example of a display screen used by a user to specify a problem generating task in the client computer according to the embodiment of this invention;

FIG. 8 illustrates an example of a supporting application DB according to the embodiment of this invention;

FIG. 9 illustrates an example of an event log record acquired in the client computer according to the embodiment of this invention;

FIG. 10 is a flow chart of grouping of operation log records according to the embodiment of this invention;

FIG. 11 illustrates an example of the operation log records grouped by process IDs and context information, and association between operation log groups by input and output information, according to the embodiment of this invention;

FIG. 12 illustrates an example of a table of an operation log group grouped by the process IDs and the context information according to the embodiment of this invention;

FIG. 13 illustrates an example of a table of another operation log group grouped by the process IDs and the context information according to the embodiment of this invention;

FIG. 14 illustrates an example of a table of still another operation log group grouped by the process IDs and the context information according to the embodiment of this invention;

FIG. 15 illustrates an example of a table of yet another operation log group grouped by the process IDs and the context information according to the embodiment of this invention;

FIG. 16 illustrates an example of a table of yet another operation log group grouped by the process IDs and the context information according to the embodiment of this invention;

FIG. 17 illustrates an example of a table of yet another operation log group grouped by the process IDs and the context information according to the embodiment of this invention;

FIG. 18 illustrates an example of a table of an integrated operation log group according to the embodiment of this invention;

FIG. 19 illustrates an example of a group name table according to the embodiment of this invention;

FIG. 20 illustrates results of grouping of the operation log records and giving names to the operation log groups according to the embodiment of this invention;

FIG. 21 illustrates an example of a list of operation log records of a problematic task according to the embodiment of this invention;

FIG. 22 illustrates an example of a past case DB according to the embodiment of this invention;

FIG. 23 illustrates an example of a problem operation table according to the embodiment of this invention;

FIG. 24 is a flow chart illustrating determination of problem solution candidates by the management server according to the embodiment of this invention;

FIG. 25 illustrates an example of a display list according to the embodiment of this invention;

FIG. 26 illustrates an example of a solution candidate display screen according to the embodiment of this invention;

FIG. 27 is a diagram illustrating an example of a method of calculating a similarity between the operation log groups according to the embodiment of this invention;

FIG. 28 illustrates an example of a help desk screen according to the embodiment of this invention; and

FIG. 29 is a flow chart illustrating presentation and registration of a problem solution by an operator according to the embodiment of this invention.

### DETAILED DESCRIPTION OF THE PREFERRED EMBODIMENT

Hereinafter, an embodiment of this invention is described with reference to the accompanying drawings. For clear description, specific details of the following description and the drawings are omitted and simplified where appropriate. A management system according to this embodiment uses an operation log acquired in a client computer to manage the client computer (user).

The management system according to an embodiment of this invention groups a plurality of operation log records acquired from the operation log in the client computer to form a plurality of operation log groups. When a problem is generated in the client computer, the management system presents solution candidates therefor.

Specifically, the management system stores in advance problem cases respectively associated with the operation log groups and solutions. The problem cases may include not only problem examples that actually occurred in any one of client computers under the management of the management system, but also problem examples registered in advance by an administrator.

The management system acquires an operation log group containing an operation log record of an operation that caused the problem in the client computer. Further, the management system compares the operation log group and the operation log groups associated with the problem cases. When an operation log group similar to the operation log group that caused the problem is stored, the management system determines the solution to the problem case associated with the similar operation log group as a solution candidate to the problem.

As described above, by comparing the operation log groups consisting of the plurality of operation log records and determining the solution associated with the operation log group similar to the operation log group in which the problem has been generated as a solution candidate for the generated problem, it is possible to select and present a more appropriate method as a solution candidate for a problem in the client computer.

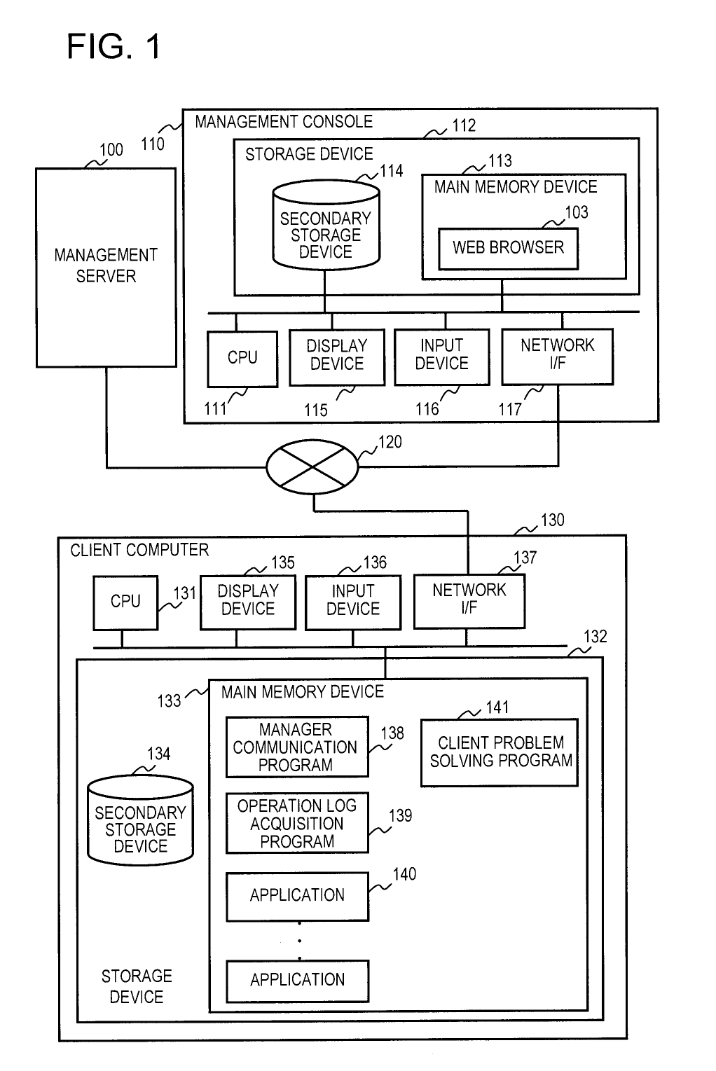

Hereinafter, management of the client computer according to this embodiment is specifically described with reference to the accompanying drawings. FIG. 1 schematically illustrates an example configuration of a computer system according to this embodiment, including the client computer operated by a user and the management system for the client computer. The management system includes a management server 100 and a management console 110. FIG. 1 illustrates one client computer 130 from which an operation log is to be acquired, but typically, a plurality of client computers are to be managed by the management system. The computers are communicably connected by a network 120.

The management console 110 is a computer used by the administrator to manage the client computer 130. The administrator accesses the management server 100 from the management console 110 to instruct the management server 100 on processing, and controls the management console 110 to acquire and display processing results of the management server 100. This way, the administrator uses the management console 110 to perform management based on the operation log of the client computer 130. The operation log management system does not need to include the management console 110, and the administrator may use an input/output device directly connected to the management server 100, instead of the management console 110.

As illustrated in FIG. 1, the management console 110 includes a CPU 111, which is a processor, a storage device 112, a display device 115, an input device 116, and a communication interface 117. The management console 110 connects to the network 120 through the communication interface 117.

The storage device 112 includes a main memory device 113 and a secondary storage device 114. The main memory device 113 is typically a volatile semiconductor memory, and stores a web browser 103, which is a program. The administrator can use the web browser 103 to access and operate the management server 100.

The CPU 111 operates as a functional part (for example, display part) which realizes predetermined functions by executing programs stored in the main memory device 113. The programs to be executed include, in addition to the web browser 103 illustrated in FIG. 1, an operating system (OS) (not shown).

For convenience of description, the web browser 103 is illustrated in the main memory device 113, but typically, the web browser 103 is loaded from a storage area of the secondary storage device 114 to a storage area of the main memory device 113. The secondary storage device 114 is a storage device including a non-volatile, non-transitory storage medium for storing programs and data necessary for realizing predetermined functions. The secondary storage device 114 may alternatively be an external storage device connected through the network 120.

Typical examples of the input device 116 are a keyboard and a pointer device, but may alternatively be a device other than the keyboard and the pointer device. The display device 115 is typically a display monitor, and displays the processing results of the management server 100. The client computer 130 is a computer used by the user, and is to be managed by the management system. The client computer 130 acquires the operation log of the user who uses the client computer 130, and transmits the acquired operation log to the management server 100.

As illustrated in FIG. 1, the client computer 130 includes a CPU 131, which is a processor, a storage device 132, a display device 135, an input device 136, and a communication interface 137. The client computer 130 connects to the network 120 through the communication interface 137. Typical examples of the input device 136 are a keyboard and a pointer device and the display device 135 is typically a display monitor, but the input device 136 and the display device 135 may alternatively be a device other than the keyboard and the pointer device, and a device other than the display monitor, respectively.

The storage device 132 includes a main memory device 133 and a secondary storage device 134. The main memory device 133 is typically a volatile semiconductor memory, and stores, in addition to an OS (not shown), a manager communication program 138, an operation log acquisition program 139, a plurality of application programs 140, and a client problem solving program 141. Those programs are parts of an operation log client program, and operation of each program is described later in detail.

The CPU 131 realizes predetermined functions by executing programs stored in the main memory device 133. For example, the CPU 131 operates in accordance with the operation log acquisition program 139 to operate as an operation log acquisition part. The same applies to the other programs. The client computer 130 is a device or system including those functional parts.

For convenience of description, the programs 138 to 141 are illustrated in the main memory device 133, but typically, the programs 138 to 141 are loaded from a storage area of the secondary storage device 134 to a storage area of the main memory device 133. The secondary storage device 134 is a storage device including a non-volatile, non-transitory storage medium for storing programs and data necessary for realizing predetermined functions. The secondary storage device 134 may alternatively be an external storage device connected through the network 120.

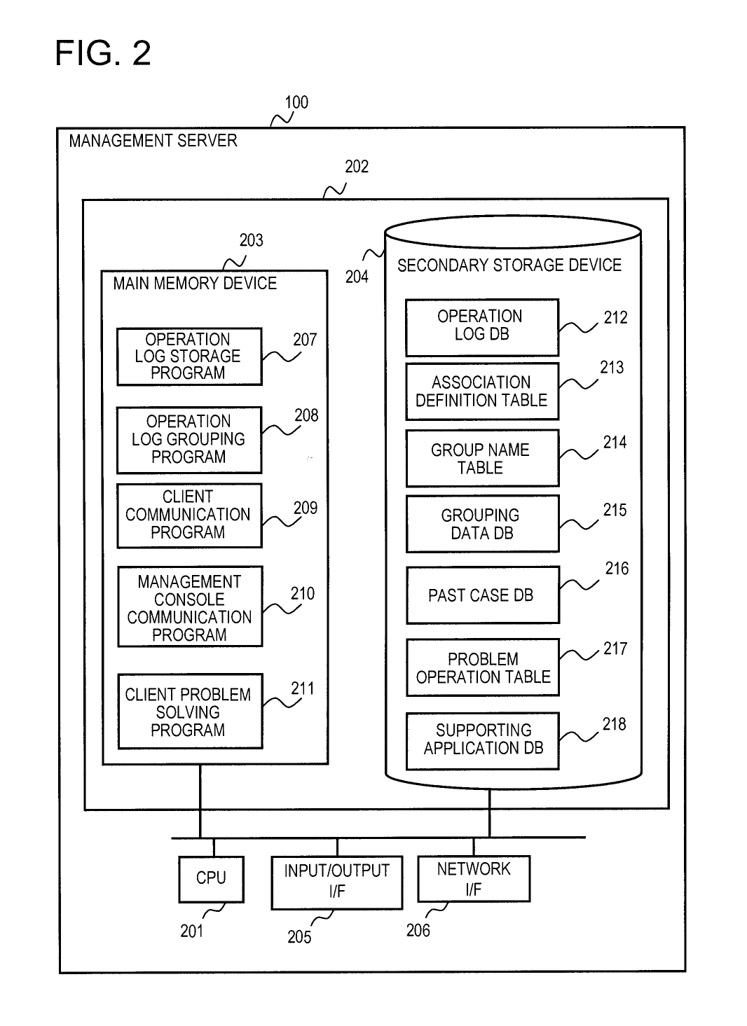

FIG. 2 schematically illustrates a configuration of the management server 100. The management server 100 is a computer, and includes a CPU 201, which is a processor, a storage device 202, an input/output interface 205, and a communication interface 206. The management server 100 connects to the network 120 through the communication interface 206.

The storage device 202 includes a main memory device 203 and a secondary storage device 204. The main memory device 203 is typically a volatile semiconductor memory, and stores, in addition to an OS (not shown), an operation log storage program 207, an operation log grouping program 208, a client communication program 209, a management console communication program 210, and a client problem solving program 211. Those programs are parts of an operation log management program, and operation of each program is described later in detail.

The secondary storage device 204 is a storage device including a non-volatile, non-transitory storage medium for storing programs and data necessary for realizing predetermined functions. In FIG. 2, stored in the secondary storage device 204 are an operation log database (DB) 212, an association definition table 213, a group name table 214, a grouping data DB 215, a past case DB 216, a problem operation table 217, and a supporting application DB 218. Those pieces of information are operation log management data. The stored information is described later in detail. The secondary storage device 204 may alternatively be an external storage device connected through the network 120.

For convenience of description, the programs 207 to 211 are illustrated in the main memory device 203, and the pieces of information (data) 212 to 218 necessary for the processing in the management server 100 are illustrated in the secondary storage device 204. However, typically, those programs and pieces of information (data) are loaded from a storage area of the secondary storage device 204 to a storage area of the main memory device 203 to be used by the CPU 201.

The CPU 201 realizes predetermined functions by executing programs while using data stored in the main memory device 203. For example, the CPU 201 operates in accordance with the operation log storage program 207, the operation log grouping program 208, the client communication program 209, the management console communication program 210, and the client problem solving program 211 as an operation log storage part, an operation log grouping part, a client communication part, a management console communication part, and a client problem solving part, respectively. The management server 100 is a device or system including those functional parts.

In the examples of FIGS. 1 and 2, the management server 100 is one computer, but alternatively, for increased speed and reliability of the management processing, processing equivalent to that executed by the management server 100 may be executed by a plurality of computers. The plurality of computers are included in the operation log management system according to this embodiment. The client computer 130 may play a partial role in the management processing, and the management system may include (some functions of) the client computer.

As described above, the programs of the management server 100, the management console 110, and the client computer 130 are executed by the CPUs 201, 111, and 131 to execute predetermined processing using the storage devices 202, 112, and 132, and other devices. Therefore, a description made with a program as the subject according to this embodiment may be a description with the CPU 201, 111, or 131 as the subject. Alternatively, the processing executed by the programs is processing performed by the computers 100, 110, and 130 on which the programs run and by the computer system including the computers 100, 110, and 130.

As described above, the client computer 130 acquires the operation log of operations performed thereon by the user, and transmits the acquired operation log to the management server 100. Specifically, the operation log acquisition program 139 running on the client computer 130 acquires operation information (operation log) of the application programs 140. The method of processing the operation log acquisition program 139 is generally known and not a feature of this invention by itself, and hence a detailed description thereof is omitted here.

The manager communication program 138 of the client computer 130 transmits the operation log acquired by the operation log acquisition program 139 to the management server 100 through the network interface 137 and the network 120.

In the management server 100, the client communication program 209 receives the operation log transmitted from the client computer 130 through the network interface 206. The client communication program 209 passes the received operation log to the operation log storage program 207.

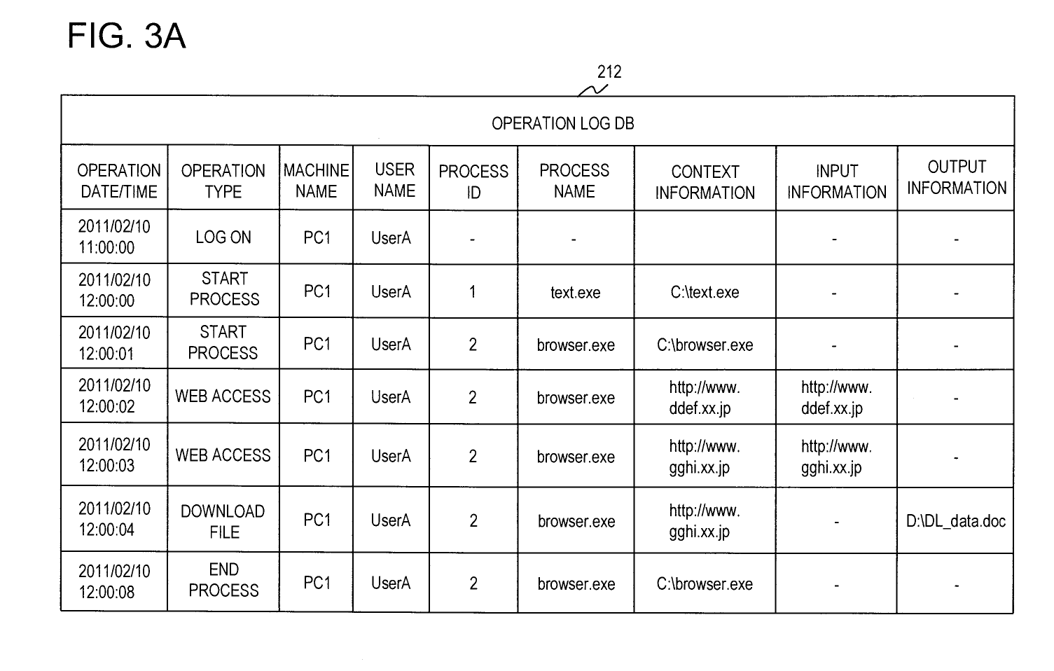

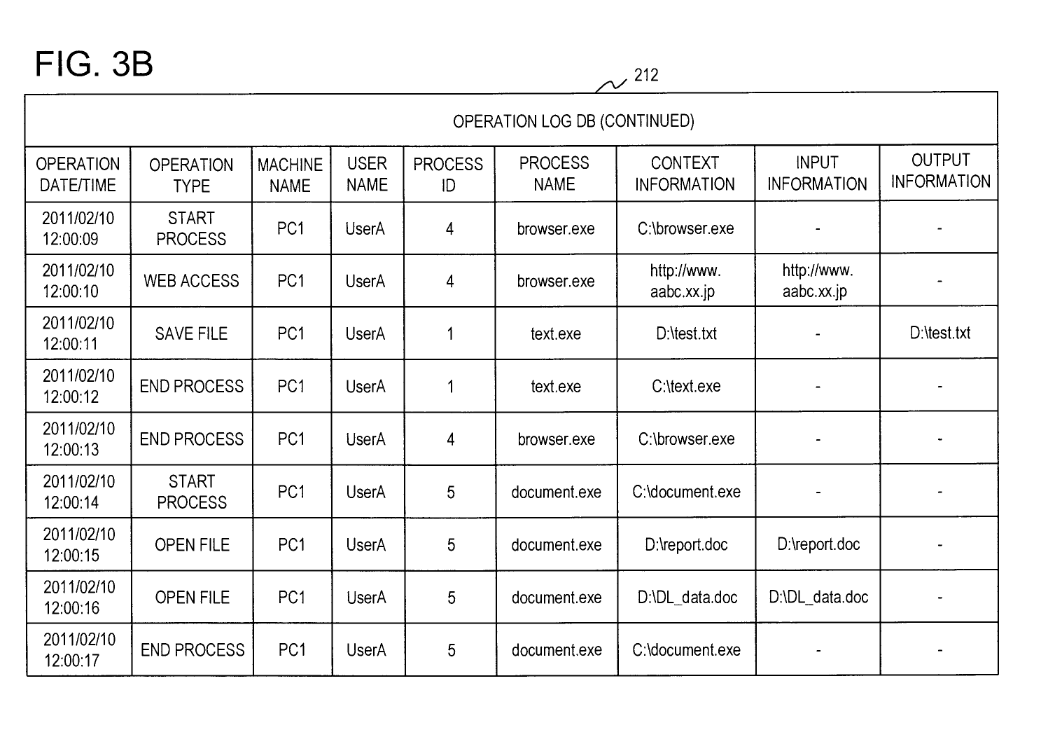

The operation log storage program 207 acquires data to be stored in the operation log DB 212 from the received operation log, and stores the data in the operation log DB 212. FIGS. 3A and 3B illustrate an example of the operation log DB 212 according to this embodiment. FIG. 3A illustrates a part of the operation log DB 212, and FIG. 3B illustrates another part (continued part) of the same operation log DB 212. In this example, the operation log DB 212 is represented by one table.

The operation log DB 212 in this example includes a column of operation date/time, a column of operation type, a column of machine name, a column of user name, a column of process ID, a column of process name, a column of context information, a column of input information, and a column of output information. The operation log DB 212 may further include not-illustrated information.

The operation date/time indicates the date and time at which an operation was performed. The operation type indicates a type of the operation performed by the user. This example illustrates, for example, operation types such as log on, start process, and open file. The machine name is a name of the client computer on which the operation was performed. The machine name is a unique identifier for identifying the client computer, and when there are a plurality of client computers, the plurality of client computers are allocated different machine names, respectively.

The user name indicates a name of the user who logged in and performed an operation. When there are a plurality of users, the user name is a unique identifier in one client computer 130, and different user names are allocated to different users in one client computer 130. When there are a plurality of client computers, typically, the user name is unique among all the client computers.

The process ID is an identifier for identifying a process in which the operation is performed. The process is an instance of a program. A plurality of processes generated from the same program may operate in parallel. The operation log acquisition program 139 may obtain a value of the process ID from, for example, the OS. As the process IDs, for example, numbers that increase monotonously are allocated to the processes according to the order in which the processes are generated. For example, numbers from a minimum value to a maximum value are allocated repeatedly in order.

The process name is a name of a process and may include, for example, a name or a part of the name of a program. For example, in this example, text.exe is a process name of a text editor, browser.exe is a process name of a web browser, and document.exe is a process name of a word processor.

The context information is information indicating the target of an operation. For example, the context information for a start process operation and an end process operation is information for identifying a program (file) for generating the process, which, in the example of FIGS. 3A and 3B, is a file path indicating an access destination. The file path is a full path to a file, and includes directory information and a file name (without directory information). The context information for an open file operation and a save file operation is also a file path of a file to be accessed.

The context information for web access is a URL of a web access destination (web page transmission source) or a part (for example, domain) of the URL. In the example of FIGS. 3A and 3B, the URL is a combination of a scheme name and a host name.

As an example, in a case where, in one process of the browser, different tab pages are displayed in a window, when access destinations of the tab pages have different domains, the operations are divided to different operation log groups. In a case where the user uses different web application programs (such as different mailers) in the same browser process, the operations are included in different operation log groups. Further, a log of unnecessary page access operations, which is generated during a search, may be eliminated. With the grouping by the URLs, a more adequate solution may be proposed considering the search task of the user. This way, with the grouping by using the URLs, it is possible to perform grouping in accordance with the user operation.

The context information for a download file operation is a URL or a part of the URL of a download source accessed for downloading the file. FIG. 3A illustrates an example of combinations of the scheme name and the host name.

Operation log records having the same process ID may have different operation types and different pieces of context information. Operation records having the same process ID and the same operation type may have different pieces of context information. For example, in FIG. 3A, of five operation log records having the process ID of 2, the context information of two web access operation records are different URLs. The input information is information for identifying an input received from an operation. Similarly, the output information is information for identifying an output generated from the operation. Details of the context information, the input information, and the output information are further described below.

In the example of FIGS. 3A and 3B, a plurality of operation log records (entries) included in the operation log DB 212 are arrayed in order of from the operation with the oldest operation date/time. Some of the operation log records store in all fields data specifically identifying details of the fields, but fields (fields indicated by hyphens) of some operation log records do not store such data. Typically, those fields store a NULL value.

Specifically, every operation log record stores specific data (data other than NULL) in the operation date/time, the operation type, the machine name, and the user name. Some operation log records do not contain the value of the process ID. Specifically, there is no specific process corresponding to a logon operation (and logoff operation). Therefore, those operation log records do not contain a specific process ID and a specific process name.

In the example of FIGS. 3A and 3B, operation records other than the log on operation record have the context information. Some of the operation log records have specific input information or specific output information, and others of the operation log records do not have any one of the input information and the output information.

Specifically, for the web access operation and the open file operation, specific inputs are defined, respectively, and information (identifiers) indicating the specific inputs are stored in the operation log records. Similarly, for the download file operation and the save file operation, specific outputs are defined, respectively, and information (identifiers) indicating the specific outputs are stored in the operation log records.

This example shows an operation log of operations by one user (user name: UserA) on one client computer 130 (machine name: PC1). However, when there are a plurality of client computers or a plurality of users, the operation log DB 212 stores an operation log for all the plurality of client computers or the plurality of users.

As described above, the operation log storage program 207 of the management server 100 obtains data of the operation log records from the operation log received from the client computer 130, and stores the obtained data in the operation log DB 212. In this configuration example, the operation log storage program 207 refers to the association definition table 213 to identify context information, input information, and output information of each operation.

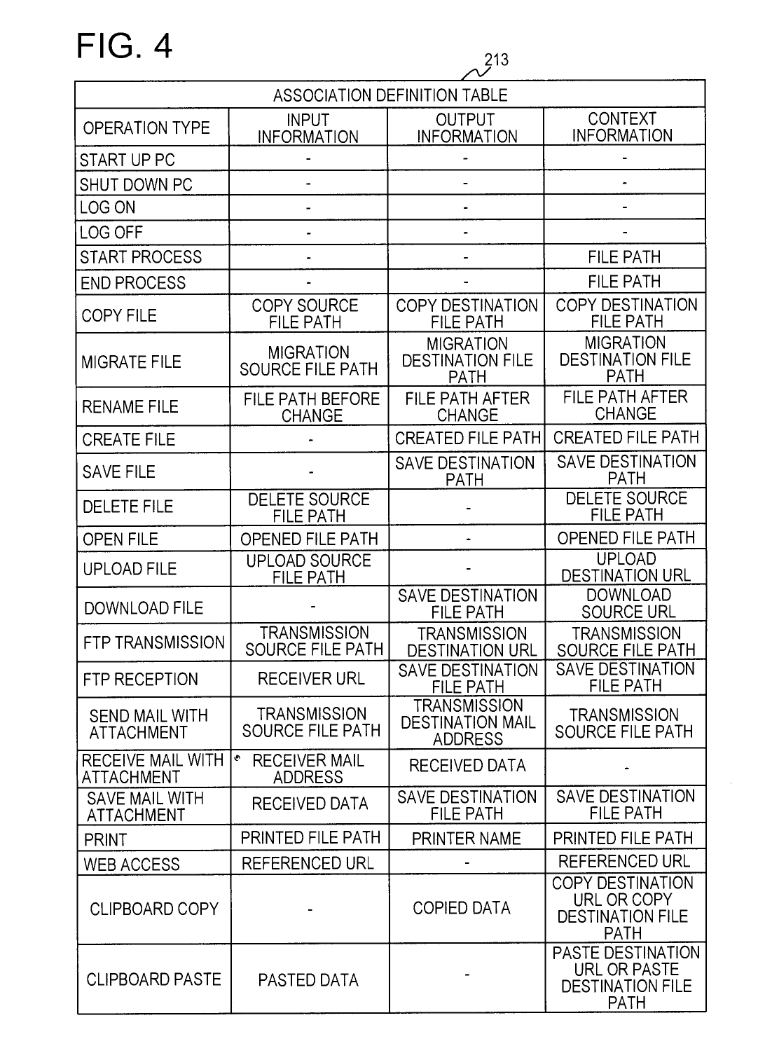

FIG. 4 illustrates an example of the association definition table 213. The association definition table 213 is merely an example, and the association definition table 213 may include another operation type, or may include another definition of information associated with each of the operation types. The association definition table 213 in this example includes a column of operation type, a column of the input information, a column of the output information, and a column of the context information. The columns of the input information, the output information, and the context information each define a type of information corresponding to each of the operation types.

As illustrated in FIG. 4, some or all of the input information, the output information, and the context information are defined for some of the operation types, while none of the input information, the output information, and the context information are defined (meaning that none are defined to exist) for others of the operation types. In those operations, input and output information, and the context information do not exist. Context information for one operation type is identical to one of the input information and the output information, or is different from the input information and the output information.

The operation type defined in the association definition table 213 is the same as the operation type registered in the operation log DB 212. It is preferred that all the operation types that can be stored in the operation log DB 212 have definitions in the association definition table 213 for their input and output information and context information (including non-existence thereof).

In this example, for example, for the operation type “start process”, the input information and the output information are not defined, and a file path is defined as the context information. It should be noted that, in the example configuration described in this embodiment, the file path is a full path to a file, and includes directory information (storage address) and a file name (without directory information).

As another example, for the operation type “copy file”, the input information is a copy source file path, and the output information is a copy destination file path. The context information is a copy destination file path as with the output information. The operation type “copy file” has both the input and the output for one operation.

As still another example, the input information and the context information for the operation type “open file” are an opened file path. For the “open file” operation, the output information is not defined. In the example of the operation log DB 212 illustrated in FIG. 3B, the operation type of the seventh operation log record is “open file”, and the input information thereof is “C:¥report.doc”. The input information is a full path to a file name “report.doc”.

As yet another example, the input information and the context information for the operation type “upload file” are an upload source file path and an upload destination URL. The output information is not defined. The input information and the context information for the operation type “download file” are an upload source file path and an upload destination URL. The output information is not defined.

For the “web access” operation, the input information and the context information are defined, each of which is a referenced URL. The output information is not defined. Information associated with the “upload file” operation and the “web access” operation may be defined by a part of the URL. This also applies to URLs in other operation types.

In addition, in the association definition table 213 of FIG. 4, the input information and the context information are defined for the operation type “clipboard copy”, and the output information and the context information are defined for the operation type “clipboard paste”. The “clipboard copy” operation includes an operation of maintaining copy source data (so-called copy operation) and an operation of deleting the copy source data (so-called cut operation). The defined input information and the defined output information are copied data and pasted data, respectively. The respective pieces of context information defined for the “clipboard copy” operation and the “clipboard paste” operation are a copy destination URL or copy destination file path.

As the input and output information or the context information associated with the operation type, appropriate information is used by design. For example, as described above, in addition to the full path of data and the data itself, a hash value of data may be used. In the case of the clipboard, a program of the clipboard sequentially allocates identifiers to copy operations and cut operations, and the allocated identifiers may be used as the above-mentioned input information and output information.

The operation log storage program 207 determines the input information, the output information, and the context information for one operation in the operation log received from the client computer 130 by referring to the association definition table 213. The operation log storage program 207 obtains the input information, the output information, and the context information defined for the selected operation from the received operation log, and stores the obtained input information, output information, and context information in the operation log DB 212.

Typically, the operation log transmitted from the client computer 130 contains more detailed information on the user operation than information to be stored in the operation log DB 212. For example, the operation log storage program 207 determines, from a plurality of events (entries) included in the received operation log, operation types corresponding to those events according to the definition information, and extracts, from those events, other data (information) to be stored in the operation log DB 212.

The operation log storage program 207 stores the thus-generated operation log records (specifically, data thereof) in the operation log DB 212. The operation log acquisition program 139 of the client computer 130 may transmit the operation log including values of the fields of the operation log records of the operation log DB 212 to the management server 100. The operation log storage program 207 may select operation log records (specifically, data thereof) from the received operation log and store the selected operation log records in the operation log DB 212. The operation log acquisition program 139 may transmit only data to be stored in the operation log DB 212 to the management server 100.

In this example, information for associating the operation type and the corresponding input information, output information, and context information is illustrated in the association definition table 213 of FIG. 4. However, the definition information for associating the operation type and the information does not need to be included in one table, and may have any data structure. The definition information may be included in the operation log storage program 207 without constituting a table.

The same applies to any information used by the management system according to this embodiment in the client computer management. Specifically, information contained in the operation log DB 212, the group name table 214, the grouping data DB 215, the past case DB 216, the problem operation table 217, and the supporting application DB 218 may be represented by any data structure. Accordingly, according to this embodiment, information does not depend on the data structure.

According to this embodiment, when a problem is generated in the client computer 130, the user can inquire of the management server 100 as to the problem. A help desk function of the management server 100 determines and presents the solution candidates for the inquired problem to the user (client computer 130). The management server 100 analyzes the operation log in the client computer 130 to determine the solution candidates for the problem based on the result of the analysis.

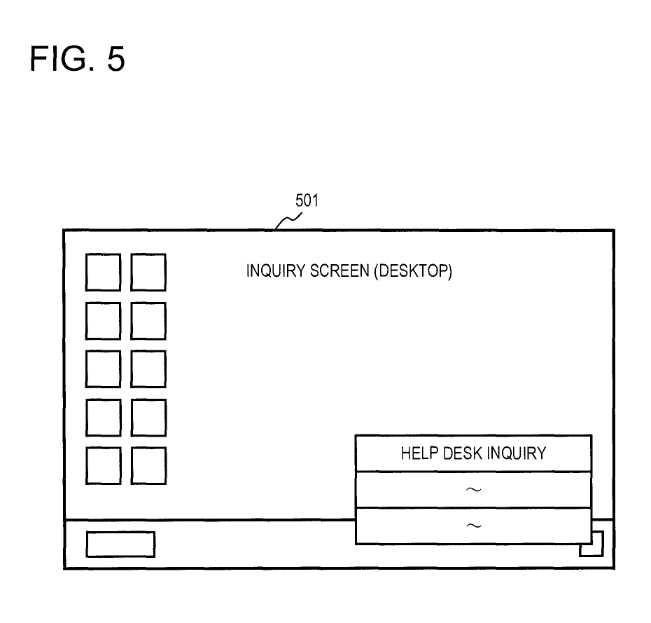

FIG. 5 illustrates an example of an inquiry screen 501 in the display device 135 of the client computer 130. FIG. 5 illustrates a desktop of the display device 135, and in the menu on the lower right, an entry “helpdesk inquiry” is displayed. When the user selects this entry by using the input device 136, the client problem solving program 141 inquires of the management server 100 as to the generated problem.

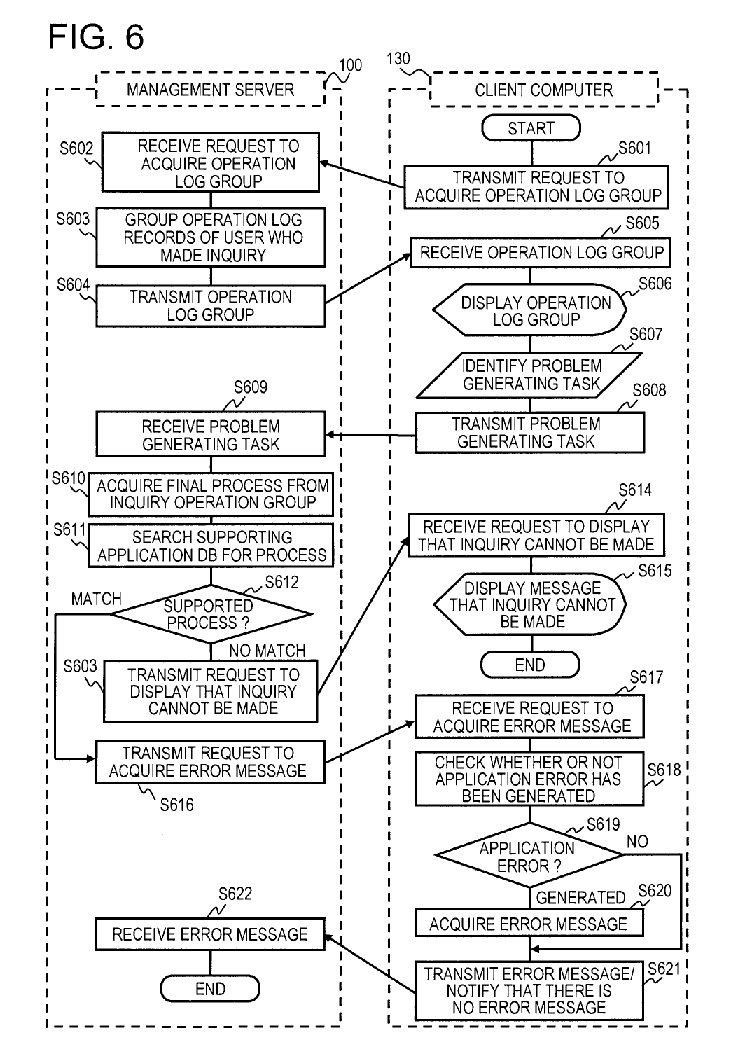

FIG. 6 is a flow chart illustrating processing for, in response to the inquiry about the problem generated in the client computer 130, acquiring information required by the management server 100 to analyze the problem, in particular, information on operation procedure performed when a problem is generated.

When a problem is generated in the client computer 130, as illustrated in FIG. 5, the user uses the input device 136 to instruct the client computer 130 to make an inquiry to the management server 100. In response to the instruction from the user, the client problem solving program 141 uses the manager communication program 138 to transmit to the management server 100 a request to acquire an operation log group (S601).

In the management server 100, the client communication program 209 receives from the client computer 130 the request to acquire the operation log group, and forwards the same to the client problem solving program 211 (S602). The client problem solving program 211 refers to the request to determine the machine name and the user name of the client computer 130 that has transmitted the request. The client problem solving program 211 instructs the operation log grouping program 208 to group the operation log records in the operation log in the current logon phase by specifying the machine name and the user name.

The operation log grouping program 208 selects, from among the operation log records having the machine name and the user name of the request transmission source, the operation log records in the current logon phase from the operation log DB 212. The operation log grouping program 208 groups the selected operation log records into one or a plurality of operation log groups (S603).

In this example, one operation log group is assumed to be a group of operation log records for one task. Further, the operation log grouping program 208 determines name (task name) of each operation log group. The grouping method and the name determining method for the operation log records are described later. It should be noted that the management server 100 may execute the acquisition of the operation log in the client computer 130 that is working and grouping of the operation log records in parallel without waiting for an external request.

The client problem solving program 211 transmits the generated one or plurality of operation log groups and the task names thereof to the client computer 130 using the client communication program 209 (S604).

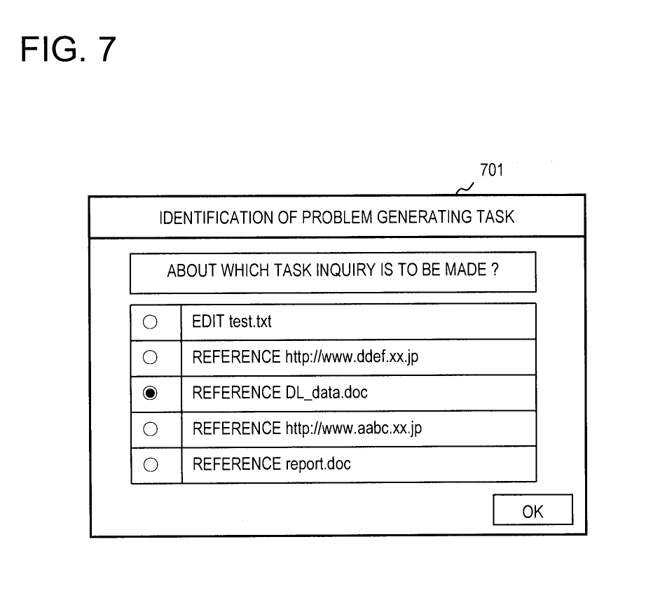

In the client computer 130, the client problem solving program 141 receives the operation log groups and the task names thereof through the manager communication program 138 (S605). The client problem solving program 141 causes the display device 135 to display information indicating the received operation log groups, in this example, the task names of the operation log groups (S606). FIG. 7 illustrates this display example.

FIG. 7 is an example of a display screen 701 used by the user of the client computer 130 to specify a problem generating task. In FIG. 7, five task entries are displayed. The entries correspond to different operation log groups. The user may use the input device 136 to select one of the entries. In FIG. 7, the third entry “reference DL_data.doc” is selected. A plurality of entries may be selectable. The user selects from the displayed entries a task that has generated a problem in the client computer 130 (S607).

Though not shown in FIG. 7, the client problem solving program 141 may display, in response to the selection by the user, details of the operation log records included in the operation log group of the selected entry. This allows the user to check the contents of each task (operation log group) and select the problem generating task more reliably.

By allowing the user to select the problem generating task, the operation log group in which the problem has been generated is appropriately selected. In contrast, the management system may select the operation log group in which the problem has been generated. The user or the management system may select a plurality of operation log groups.

The client problem solving program 141 determines the task (operation log group) selected by the user as the problem generating task (operation log group), and transmits information indicating the problem generating task to the management server 100 by using the manager communication program 138 (S608).

The manager communication program 138 receives from the client computer 130 the information indicating the problem generating task (S609). In the management server 100, the client problem solving program 211 selects, in the operation log group of the problem generating task indicated by the received information, the final operation log record and acquires the process name thereof (S610). Further, the client problem solving program 211 searches the supporting application DB 218 for the acquired process name (S611).

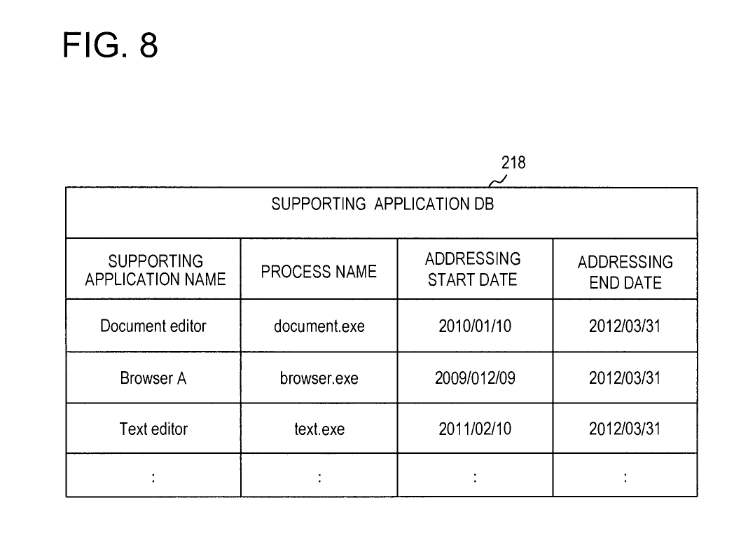

FIG. 8 illustrates an example of the supporting application DB 218. In the supporting application DB 218, application programs supported by the help desk function of the management server 100 are registered. Specifically, the supporting application DB 218 includes a column of supporting application name, a column of process name, a column of addressing start date, and a column of addressing end date. The columns store information on a name of an application program for which a help desk service is provided, a process name of the application program, a start date of addressing by the service, and an end date of addressing by the service.

When the process name acquired in Step S610 is not registered in the supporting application DB 218 (S612: no match), the process (application program) is not eligible for the service provided by the help desk function. Therefore, the client problem solving program 211 transmits to the client computer 130 a request to display that the inquiry cannot be made (S603).

In the client computer 130, the client problem solving program 141 receives through the manager communication program 138 the request to display that the inquiry cannot be made (S614). In response to the received request, the client problem solving program 141 causes the display device 135 to display a message that the inquiry cannot be made (S615).

In this example, in Step S611, the process name of the last operation log record is searched for. This is because it is possible to suppose that the problem has been generated in the process (application program) of the last operation log record. Alternatively, the client problem solving program 211 may set such a condition for performing problem solving that all application programs in the operation log group are registered in the supporting application DB 218.

The client problem solving program 211 may identify the problem generating process by referring to the generated events. The client problem solving program 211 acquires from the event log of the client computer 130 a record whose type is error, and acquires the process name from the information of the record. The client problem solving program 211 determines a process whose process name and event occurring date/time are included in the problem generating procedure as the problem generating process.

When the process name acquired in Step S610 is registered in the supporting application DB 218 (S612: match), the process (application program) is eligible for the service provided by the help desk function. The client problem solving program 211 transmits to the client computer 130 a request to acquire an error message (S616).

In the client computer 130, the client problem solving program 141 receives through the manager communication program 138 the request to acquire the error message (S617). The error message is a message to be displayed to the user in response to an error during execution of an application program. The request to acquire the error message specifies, for example, an application name.

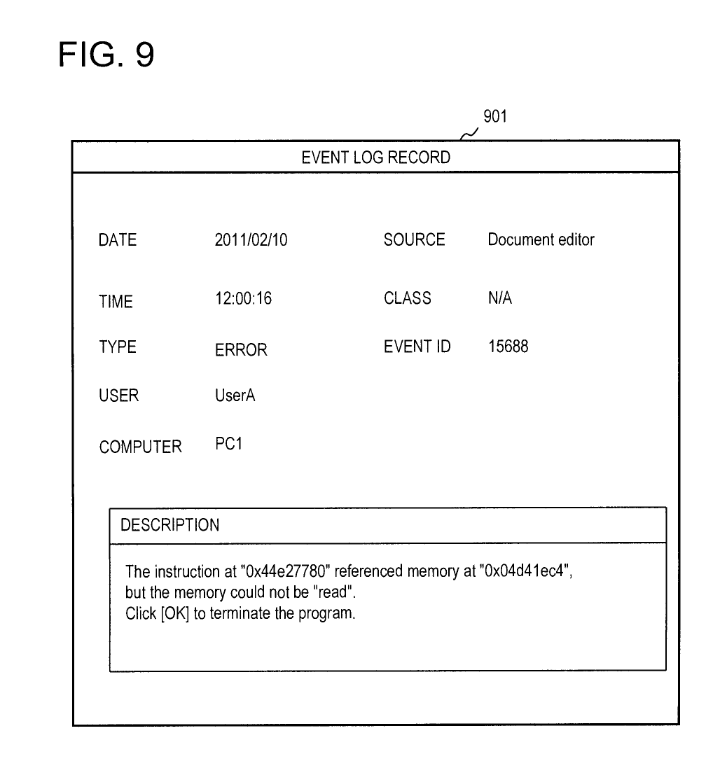

FIG. 9 illustrates an example of an event log record 901. The event log record 901 is an error event log record and describes details of the error. Specifically, the event log record includes, not only information on a date and time at which the error is generated, the user, the machine (computer), and the error generating application (source), but also a description that specifically describes the error content. The client problem solving program 141 transmits the error description (error message) in the event log record as well as other necessary information to the management server 100.

The client problem solving program 141 checks whether or not an application error for which the request is received has been generated (S618). Specifically, the client problem solving program 141 searches the event log for the above-mentioned application error. Typically, the OS records the event log.

When the error message for the above-mentioned application program exists in the event log (S619: generated), the client problem solving program 141 acquires the error message (S620) and transmits the error message to the management server 100 (S621). When the error message does not exist in the event log (S619: no), the client problem solving program 141 notifies the management server 100 that there is no error message (S621).

In the management server 100, the client problem solving program 211 receives, through the client communication program 209, the error message or the notification that the error message does not exist from the client computer 130 (S622).

In the following, the grouping of the operation log records in Step S603 of the flow chart of FIG. 6 is described in detail. The operation log grouping program 208 of the management server 100 groups the operation log records stored in the operation log DB 212. The operation log grouping program 208 groups, in the operation log, the operation log records so that operation log records which are highly associated and assumed to be included in a series of operations are put in the same group.

The grouping of the operation log records in this embodiment mainly includes two steps. The first step is to determine a group to which the operation log record belongs from attributes of the operation log record. The operation log grouping program 208 refers to data included in the operation log record to determine the group of the log record.

Specifically, in this step, the group to which the operation log record belongs is determined based on a group identifier included in the operation log record, which, in this preferred configuration, is the process ID. In the configuration described below, operation log records having different process IDs are put in different groups.

In this preferred configuration, the operation log grouping program 208 determines the group to which the operation log record belongs based further on a second group identifier that is different from the process ID. Specifically, the operation log grouping program 208 groups the operation log records by the context information.

As described above, in this preferred configuration, the operation log grouping program 208 groups the operation log records by two different types of group identifiers, that is, the process IDs and the context information. By grouping by a plurality of different identifiers, grouping that is more relevant to the user operation can be performed. Especially by using the process IDs, which is the subject of the operation, and the context information, which is the object of the operation, a solution candidate that is more suitable to the generated problem can be selected.

In the next step, different groups assumed to be included in a series of operations of the same task are associated with each other. The operation log grouping program 208 determines the relationship between the different groups by the output information and the input information of the operation log records belonging to the different groups. With the relationship of the output information and the input information between the different groups, association of the series of operations performed through a plurality of processes may be appropriately recognized, and the user task may be appropriately estimated from the operation log of the client computer 130. By thus integrating a plurality of groups by the input and output information, the series of operations (group of operations) in the same task are appropriately associated with each other.

Specifically, the operation log grouping program 208 associates different groups including operation log records whose output information and input information match. The operation log grouping program 208 assumes two groups including the operation log records whose output information and input information match to be included in a series of operations of the same task, and puts the two groups in an integrated group.

The operation log grouping program 208 determines association between the groups by the input and output information as described above, and generates one integrated group from a plurality of groups relating to each other. One group may relate to a plurality of groups by the input and output information, and one group may relate, through another related group, to still another group in succession. The integrated group includes the plurality of groups thus associated by the input and output information, and may include three or more groups.

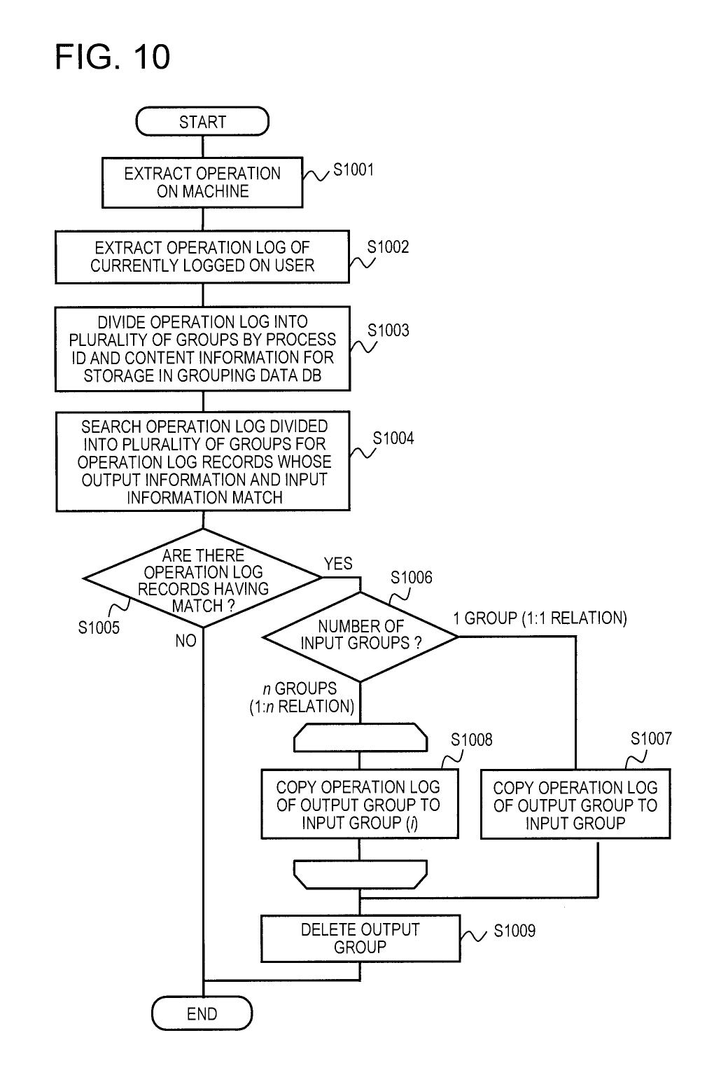

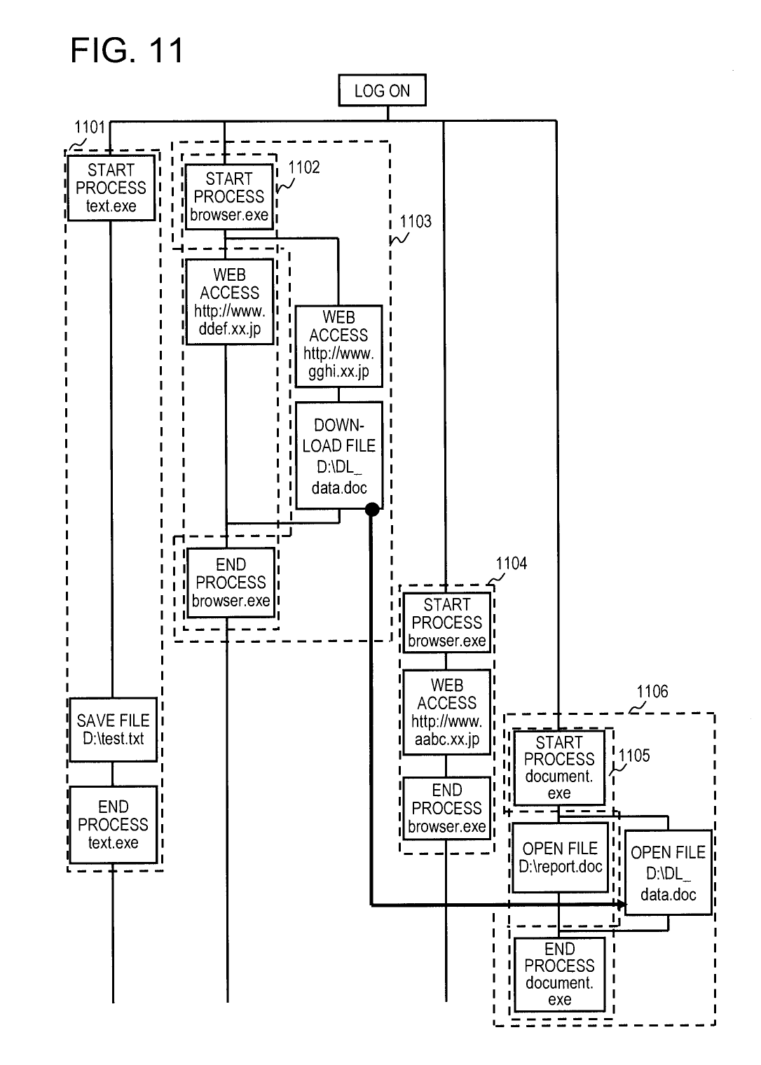

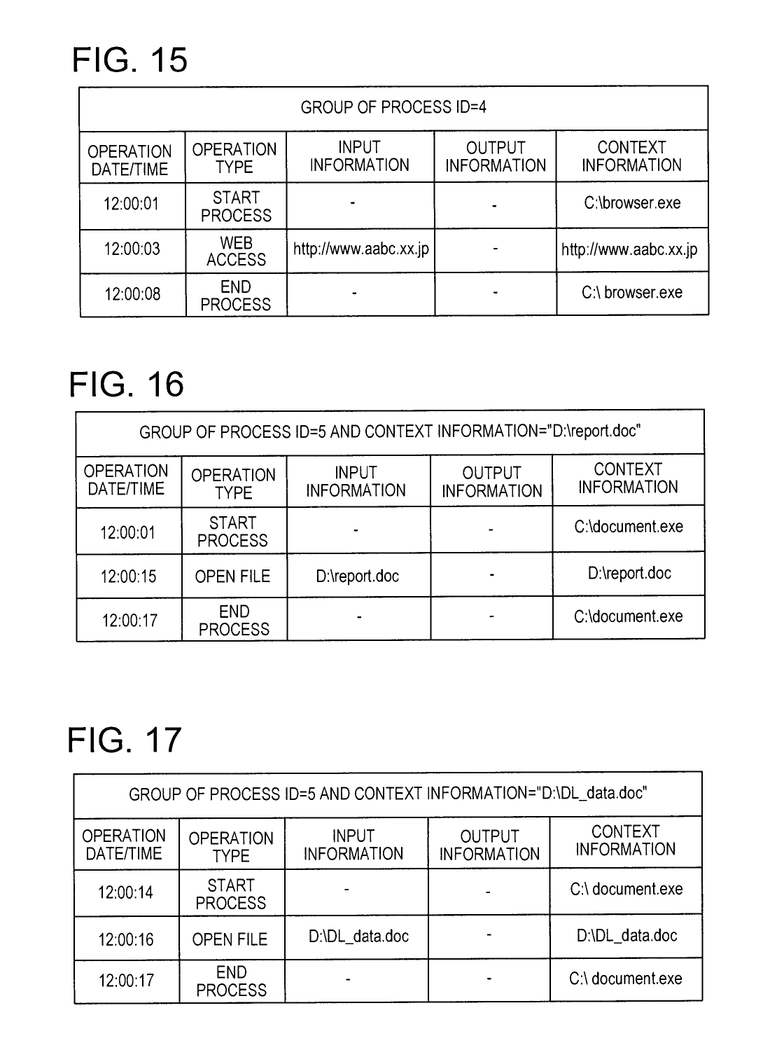

In the following, details of the steps in the flow chart of FIG. 6 are described with reference to specific examples. First, referring to a flow chart of FIG. 10 and tables of FIGS. 11 to 18, an example of grouping of the operation log records by the operation log grouping program 208 is described. FIGS. 11 to 18 illustrate tables stored in the grouping data DB 215. Some of the tables are stored temporarily and then deleted.

The operation log grouping program 208 first extracts, from the operation log DB 212, the operation log on the client computer 130 from which the request is received (S1001). Next, the operation log grouping program 208 extracts, from the extracted operation log on the client computer 130, an operation log of a currently logged on user (S1002). In Steps S1101 and S1102, the operation log after logon of the user on the client computer 130 that has generated the problem is extracted. The extracted operation log is stored in the storage device 202.

Next, the operation log grouping program 208 divides the extracted operation log into groups by the process IDs and the context information, and stores the groups obtained by the division in the grouping data DB 215 (S1003). Specifically, as described above, the operation log grouping program 208 refers to the process IDs of the operation log records of the extracted operation log, and puts the operation log records having the same process ID in the same group.

FIG. 11 schematically illustrates a result of dividing the operation log records of the operation log DB 212 illustrated in FIGS. 3A and 3B into groups based on the process IDs and the context information. In FIG. 11, blocks indicating the operation log records are arrayed in chronological order in which operations occurred. The block of start process or stop process includes the operation type and the context information. The other blocks include the operation types and the input and output information (input information or output information).

In FIG. 11, six operation log groups including the operation log groups 1101 to the operation log groups 1106 are illustrated. Each operation log group includes the blocks (operation log records) of start process and end process having the process ID. The operation log records of start process and end process have different context information than that of the other operation log records within the operation log group in which the operation log records of start process and end process are included, but are still put in the operation log group in the grouping by the process IDs because the operation log records of start process and end process are the start and end operations of the series of operations.

As described above, of the operation log records having the same process ID, the operation log records having the same context information are put in the same group. In this example, the operation log groups which have the same process ID and are divided by the context information share the operation log records of start process and end process. The operation log records having different context information except for the operation log records of start process and end process are put in different operation log groups.

The group 1101 is an operation log group of the process ID=1 and consists of operation log records with the process ID=1. Only one operation log record (having one type of context information) is included in the operation log record of the process ID=1 except for the operation log records of start process and end process, and is not divided by the context information. The group 1104 is a group of the process ID=4 and consists of operation log records with the process ID=4. The operation log record of the process ID=4 is not divided by the context information, either.

The group 1102 is a group consisting of the operation log records of start process and end process with the process ID=2, and an operation log record which has the process ID=2 and context information of a specific URL (see FIG. 11). The group 1103 is a group consisting of the operation log records of start process and end process with the process ID=2, and operation log records which have the process ID of 2 and context information of another URL (see FIG. 11). As such, the operation log records with the process ID=2 are divided into two operation log groups by the context information.

The group 1105 is a group consisting of the operation log records of start process and end process with the process ID=5, and an operation log record which has the process ID=5 and context information of “D:¥report.doc”. The group 1106 is a group consisting of the operation log records of start process and end process with the process ID=5, and an operation log record which has the process ID of 5 and context information of “D:¥DL_data.doc”. As such, the operation log records with the process ID=5 are divided into two operation log groups by the context information.

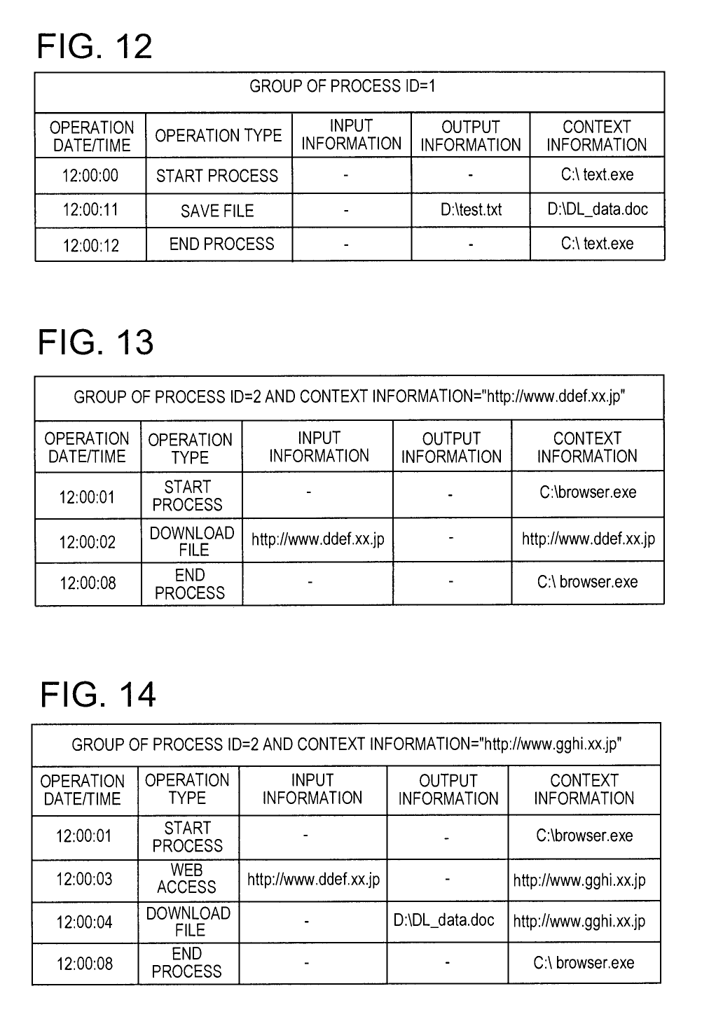

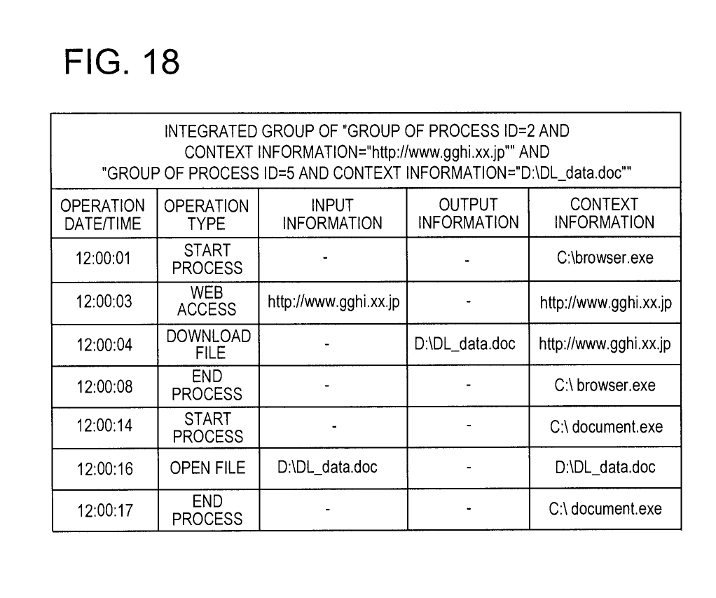

Tables of FIGS. 12 to 17 show details of the groups 1101 to 1106. The tables are stored in the grouping data DB 215. Each table includes columns of operation date/time, operation type, input data, and output data. Other columns may also be included. As described below, of the tables, the table of the group 1103 and the table of the group 1106 are integrated into one table illustrated in FIG. 18 by the integration of the operation log groups.

FIGS. 12 to 18 each illustrate each group of FIG. 11 as one table for convenience. However, as described above, information on the results of the grouping by the process IDs and the context information may be represented by any data structure. The information included in the results of the grouping depends on design.

Next, the operation log grouping program 208 searches the operation log records divided into the groups by the process IDs and the context information for operation log records whose output information and input information match (S1004). The search is performed for those in the relationship of operation log records belonging to different groups, and excludes matches of the output information and the input information within the same group.

When operation log records whose output information and input information match are found in this search, the operation log grouping program 208 assumes the groups to which the operation log records belong to relate to each other. FIG. 11 illustrates the operation log records of different operation log groups whose output information and input information match.

In FIG. 11, the output information of the operation log record of “download file” in the group 1103 is “D:¥DL_data.doc”. The input information of the operation log record of “open file” in the group 1106 is also “D:¥DL_data.doc”.

The operation log grouping program 208 judges that the operation log record of “download file” of the group 1103 and the operation log record of “open file” of the group 1106 relate to each other, and, assuming the groups 1103 and 1106 to which the operation log records belong to be a series of operation groups of the same task, associates the groups 1103 and 1106 with each other.

In the following description, the group (group at the tail of the arrow) having the operation log record of the output information is referred to as an output group, and the group (group at the head of the arrow) including the same data as the output information in the operation log record of the input information is referred to as an input group. In this example, the group 1103 is an output group, and the group 1106 is an input group.

When the result of the search in Step S1004 indicates that there are operation log records having a match (S1005: YES), the operation log grouping program 208 proceeds to Step S1006. When there is no operation log record having a match (S1005: NO), the flow ends.

In Step S1006, the operation log grouping program 208 judges the number of groups in which the operation log records have the same input information with respect to output information of one operation log record. When the number is 1, the operation log grouping program 208 proceeds to Step S1007. In this example, with respect to the output information of the “download file” operation in the group 1103, the number of groups having the same input information is 1, and the group is the group 1106. In Step S1007, the operation log grouping program 208 copies the operation log included in the output group to the input group.

When the number is n (integer of 2 or greater), the operation log grouping program 208 proceeds to Step S1008. In Step S1008, the operation log grouping program 208 copies the operation log included in the output group to an input group i (each of a plurality of sequentially selected input groups). The operation log grouping program 208 executes Step S1008 for all the groups found in Steps S1005 and S1006.

The operation log grouping program 208 does not necessarily need to copy the above-mentioned operation log, as long as the output group and the input group may be associated with each other to form the integrated group. For example, the operation log grouping program 208 stores information associating (defining) the groups constituting the integrated group in the storage device 202. This also applies to Step S1007.

In Step S1009, the operation log grouping program 208 deletes the table of the output group (in this example, the table of FIG. 14) from the grouping data DB 215. In the examples illustrated in FIGS. 12 to 17, the operation log grouping program 208 copies the operation log records of the group 1103, which is an output group, to the corresponding input group 1106. The table of the output group 1103 is, in Step S1009, deleted from the grouping data DB 215.

FIG. 18 illustrates operation log records of the integrated group. FIG. 18 is a table illustrating details (operation log records) of an integrated group of the group 1103 (see FIG. 14) and the group 1106 (see FIG. 17).

The grouping data DB 215 stores, in addition to information on the above-mentioned integrated group, the operation log records in another group which is not integrated with any group or deleted. The integrated group includes all operations assumed to be operations performed by the user in the same task. The five groups are assumed to correspond to different user tasks, respectively.

The operation log grouping program 208 determines, based on the output information from a group and the input information to another group, association between the groups. As is apparent from the above description, in a pair of an operation of outputting data (output operation) and an operation of receiving data (input operation), the input operation comes after the output operation. The operation log grouping program 208 searches, in input operations executed after an output operation, for an input operation whose input information matches with the output information.

In order to avoid associating two operations which are unrelated, typically, the operation log grouping program 208 searches operations within a predetermined number of steps or operations in a predetermined time period from the output operation for an operation whose input information matches with the output information.

Typically, the operation log grouping program 208 associates related operations based on the input information and the output information in accordance with the time series of the operation execution date/time. Thereafter, the operation log grouping program 208 integrates the related groups in accordance with the chronological order of the associated pairs of an output operation and an input operation.

For example, when the operation log of the output group is to be copied to the input group in the group integration, the operation log grouping program 208 sequentially selects the associated pairs of an output operation and an input operation in chronological order of the execution date/time, and copies the operation log of the output group to the corresponding input group. As described above, one output operation may form a plurality of pairs with a plurality of input operations, and one output group may be copied to a plurality of input groups.

Three or more groups may be integrated in one group in succession. The operation log grouping program 208 integrates the output group with the input group, and repeats the integration to generate the final integrated groups. When the input group is copied to another input group in a subsequent step as an output group, all the operation log records that have been integrated are copied. The group which is an input group and also is an output group associates other two groups with each other.

As described above with reference to FIG. 6, in response to a request from the client computer 130, the management server 100 groups the operation log and names results of the grouping (operation log groups) (S603). The name allows the user to immediately recognize the operation log group including the operation log record in which the problem has been generated, and the system can support the user more effectively.

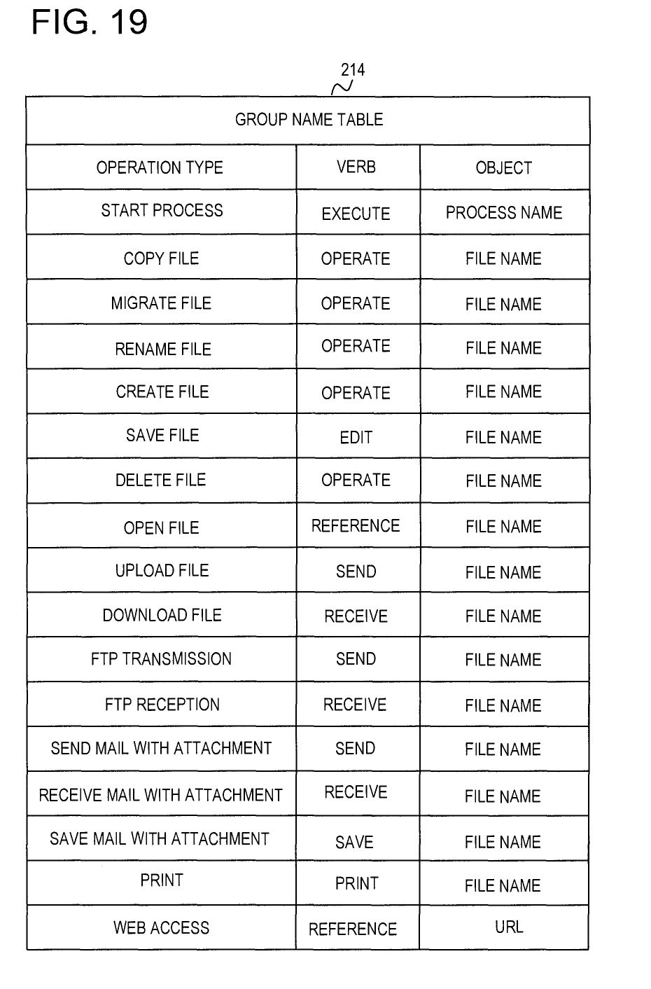

In the following, the determination method is described. In this example, the operation log grouping program 208 refers to the group name table 214 exemplified in FIG. 19 to determine a name of each group (integrated and non-integrated groups).

In the example illustrated in FIG. 19, the group name table 214 defines, for an operation type, a verb and a data type of an object thereof. The task name of a group (integrated or non-integrated group) is generated by combining the verb and the object. For example, when a name is determined by a “start process” operation, the name is “execute” “process name” (the process name depends on each operation).

The operation log grouping program 208 identifies an operation type of an operation log record selected from the group, and selects the verb and the data type of the object associated with the operation type from the group name table 214. The operation log grouping program 208 acquires data of the data type of the selected object from the operation log DB 212 or the grouping data DB 215 and generates a name of the group (task) from the data of the verb and the object.

The operation log grouping program 208 sequentially selects the operation log groups obtained by the grouping to generate names of the operation log groups (tasks). The operation log grouping program 208 selects from the selected operation log group information on the newest operation log record, which corresponds to any one of the entries of the group name table 214.

The operation log grouping program 208 refers to the group name table 214 to identify the verb and the data type of the object of the selected operation type, and acquires data of the data type of the object from the operation log DB 212. The operation log grouping program 208 further generates a name of the task (group) from the acquired data of the verb and the object.

When there is no operation log record which corresponds to any one of the entries of the group name table 214, that is, when there is no operation (operation log record) for generating a task (group) name in the operation log of the group, the operation log grouping program 208 generates a name of the group by using the operation type of the newest operation log record in the group.

By determining the group name in accordance with the information in the operation log of the group, an appropriate name may be given to the task of the group. Further, by preparing the definition information for associating the operation type and the task name in advance and determining the task name (group name) based on the operation type and the definition information selected from the group, a more appropriate name may be given to the task of the group.

The operation log grouping program 208 may generate a name based on an operation type selected by a method different from the above-mentioned method. For example, priorities may be given to the operation types, and the operation log grouping program 208 may select the operation type to be used in determining the name in accordance with the priorities. The operation log grouping program 208 does not necessarily need to use the definition information. The group name table 214, which is the definition information in this example, indicates the verb and the data type of the object associated with the operation type, but a different method of determining the name may alternatively be used.

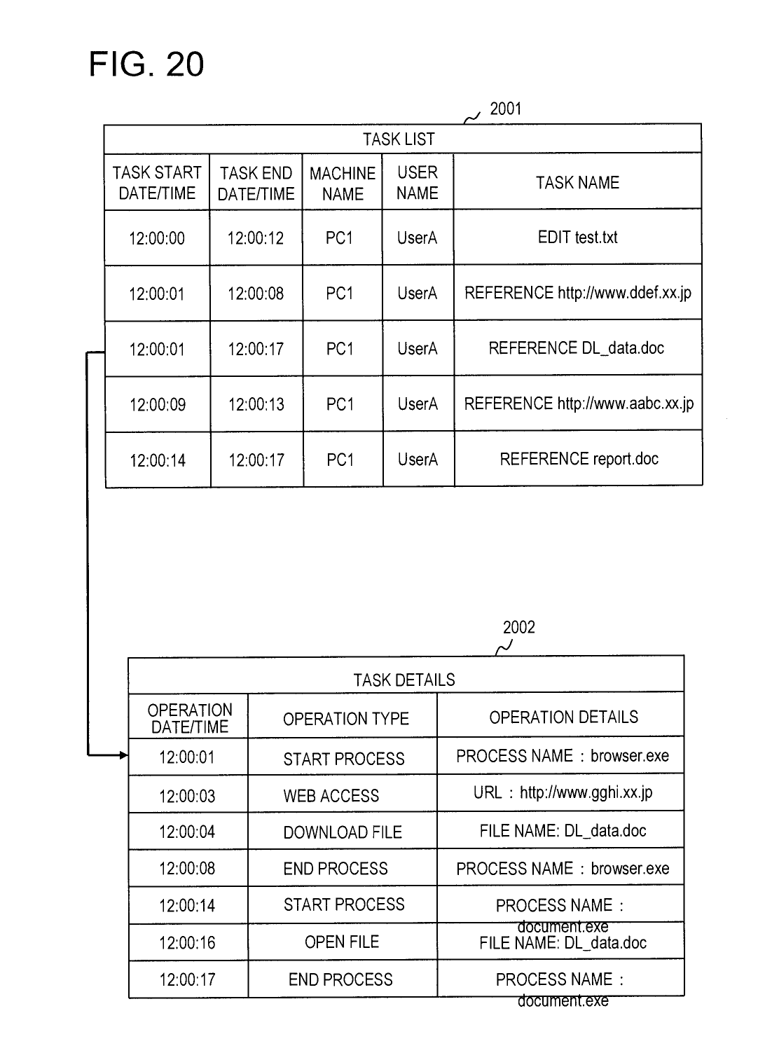

FIG. 20 illustrates a result of the grouping of the operation log records and the naming of the operation log groups, which are described above with reference to FIGS. 11 to 19. This piece of information is transmitted to the client computer 130 in response to the request from the client computer 130 (S604 in FIG. 6). In FIG. 20, entries of a task list table 2001 correspond to the five operation log groups described above with reference to FIGS. 11 to 18. The task list table 2001 includes columns of task start date/time, task end date/time, machine name, user name, and task name.

The task start date/time corresponds to the operation date/time of the first operation log record in each operation log group. The task end date/time corresponds to the operation date/time of the last operation log record in each operation log group. The task name is determined in accordance with the definition table illustrated in FIG. 19. In the task list table 2001, the first to fifth entries correspond to the group 1101, the group 1102, the integrated group of the groups 1103 and 1106, the group 1104, and the group 1105, respectively.

In FIG. 20, a task details table 2002 stores detailed information of operation log groups, specifically, information of the operation log records, which are constituent elements. FIG. 20 exemplifies the task details table 2002 of the third entry of the task list table 2001, but task details tables of the other operation log groups are also generated. The task details table 2002 includes columns of operation date/time, operation type, and operation details. The field of operation details stores information on operation details of the corresponding operation log record, and in this example, stores information included in the context information.

The task names of the operation log group shown by the task details table 2002 are described. In the operation log records shown by the task details table 2002, the operation type of the newest operation log record is “end process”. In the group name table 214 illustrated in FIG. 19, the operation type “end process” is not defined. The operation type of the next newest operation log record is “open file”. In the group name table 214 illustrated in FIG. 19, the operation type “open file” is defined, and its verb and object are “reference” and a file name, respectively.

As shown by the task details table 2002, the file name of the second newest operation log record is “DL_data.doc”. Therefore, the task name of the operation log group is, as shown in the task list table 2001, “reference DL_data.doc”. Names of the other operation log groups are given in a similar manner.

As described above with reference to FIG. 6, the client problem solving program 211 in the management server 100 transmits the result of the grouping of the operation log records, which includes the task names of the operation log groups, to the client computer 130 (S604). The grouping result illustrated in FIG. 20 corresponds to the display example illustrated in FIG. 7.

As described above with reference to FIG. 7, in a preferred configuration, the client computer 130 displays details (operation log records) of the selected task in response to a request by the user to display the task details. As described above, the task details are stored in the task details table 2002. When there is no need to display the task details, the management server 100 does not need to transmit the task details table 2002 to the client computer 130.

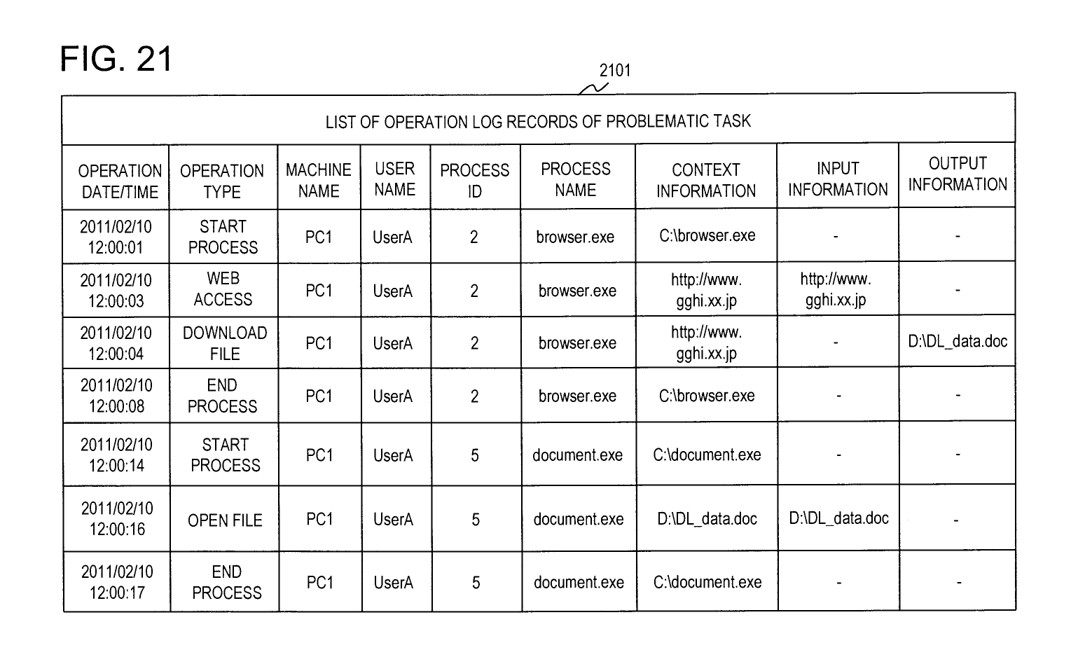

In the example described above with reference to FIG. 7, the user selects the task “reference DL_data.doc” to make an inquiry for problem solving (S607). The client problem solving program 211 in the management server 100 generates a list of operation log records included in the operation log group of the task. FIG. 21 illustrates an example of the list of the operation log records of the problematic task. The operation log records included in this list correspond to the operation log records included in the table illustrated in FIG. 18. In this example, in addition to the columns of the table illustrated in FIG. 18, the list includes columns of machine name, user name, process ID, and process name.

In S610, the client problem solving program 211 acquires the process of the last operation log record from the inquired operation log group. In the example of the list of the operation log records of FIG. 21, the process of the last operation log record is “document.exe”. The client problem solving program 211 searches the supporting application DB 218 (see FIG. 8) for the process (S611). In the supporting application DB 218, the application for the process is registered (S612: match).

The client problem solving program 211 transmits to the client computer 130 a request to acquire an error message specifying an application name (S616). The client problem solving program 141 in the client computer checks whether or not the application error for which the request is received has been generated (S618).

In this example, it is assumed that an application error has been generated, and that there is the event log record 901 illustrated in FIG. 9. The client problem solving program 141 acquires the error message including the description in the event log record 901 and transmits the acquired error message to a management server 110 (S621).

Next, problem solving by the management server 100 is described. The management server 100 refers to the operation log group specified by the client computer 130, determines a solution candidate for the problem which has been generated in the operation log group, and presents the determined solution candidate to the client computer 130 (user). The management server 100 compares the operation log groups of the registered problematic entries and the current problematic operation log group, and determines the solution candidate for the current problem from the result of the comparison.

Specifically, in the management server 100, the problem examples associated with the operation log groups and the problem solutions are registered. The management server 100 compares the operation log group specified by the client computer 130 and the registered operation log groups to search for an operation log group similar to (including an identical case) the operation log group that is the current problem.

When there is a similar operation log group, the management server 100 determines the solution associated with the operation log group as a solution candidate for the current problem. One or a plurality of registered entries may be similar to the operation log group that is the current problem. In some cases, there may be no similar entry. By determining the solution candidate to the current problem by comparing the operation log groups including the series of operation log records, it is possible to determine a problem similar to the current problem in cause and its solution, and hence to present a more appropriate solution to the current problem.

In this configuration example, the management server 100 includes the past case DB 216. The past case DB 216 includes a table in which past problem cases are registered and is referred to for problem solving. The management server 100 searches the past case DB 216 for an entry similar to the operation log group of the current problem. In this preferred configuration, to the past case DB 216, a new entry that is solved or unsolved is added. The past case DB 216 may include, in addition to the problem examples that have actually been generated in any one of the client computers, the problem examples that are registered in advance by the administrator.

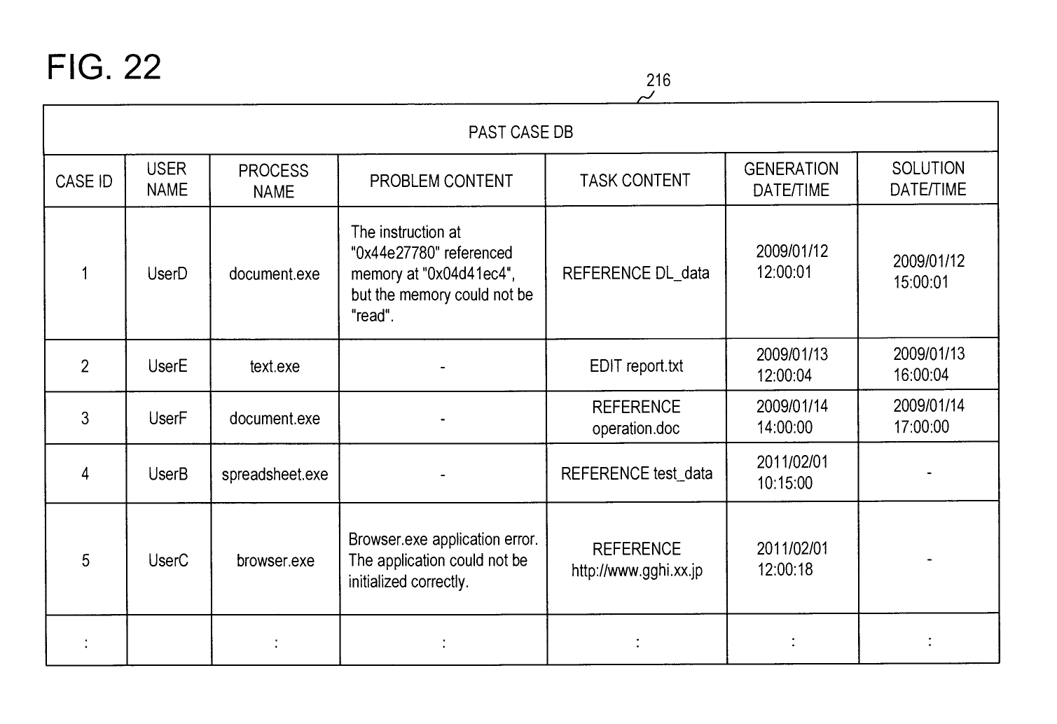

FIG. 22 illustrates an example of the past case DB 216. The past case DB includes columns of case ID, user name, process name, problem content, task content, generation date/time, and solution date/time. In this example, the past case DB 216 includes, in addition to entries of solved problems, entries of unsolved problems. Entries for which the solution date/time is not registered are unsolved problems.

The case ID is an identifier for uniquely identifying a problem entry in the past case DB 216. The user name and the process name are the same as in other tables. The column of problem content stores an error message of the problem. For some problems, there is no corresponding error message.

The column of task content stores the task name of the operation log group that is determined by referring to the group name table 214. The generation date/time represents the date and time at which the problem was generated, which is, for example, the date and time registered in the event log in the client computer 130 or the date and time at which the request to acquire the operation log group was received from the client computer 130. The solution date/time represents the date and time at which the problem was solved, which is registered by the operator at the help desk, for example.

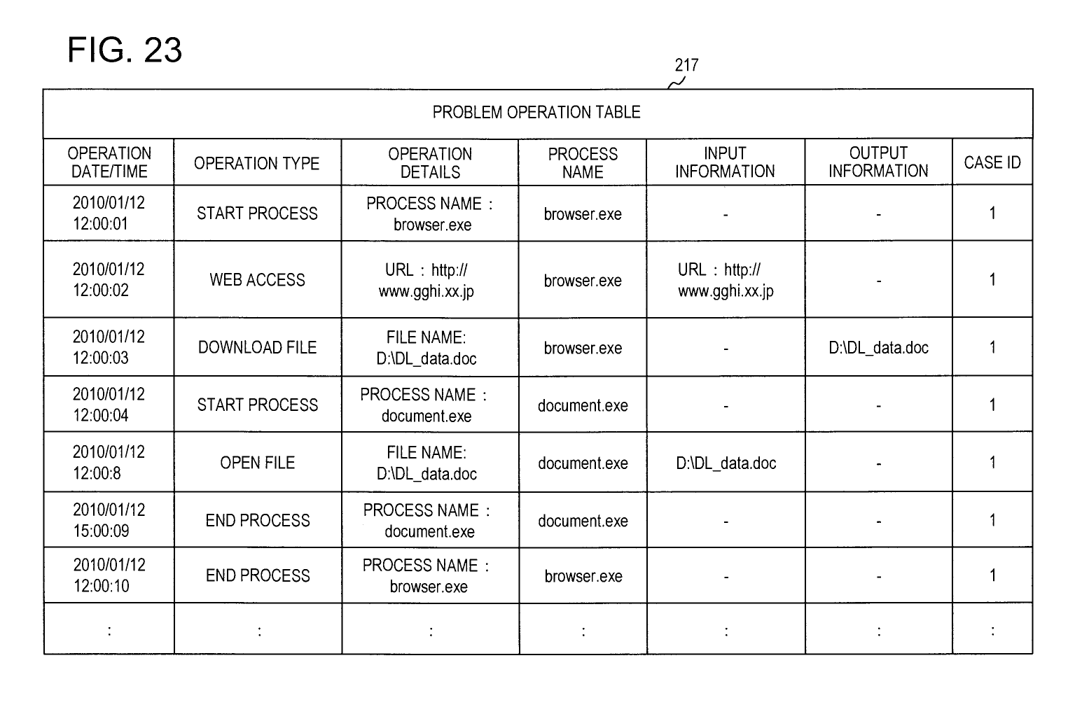

FIG. 23 illustrates an example of the problem operation table 217. The problem operation table 217 stores details of the entries of the past case DB 216. Each entry of the past case DB 216 is associated with an operation log group in which the problem has been generated, and the problem operation table 217 stores operation log records of the operation log group. An entry of the past case DB 216 and an entry of the problem operation table 217 are associated with each other by the case ID.

Each entry of the problem operation table 217 is an operation log record, and includes columns of operation date/time, operation type, operation details, process name, input information, output information, and case ID. The case ID corresponds to the case ID of the past case DB 216. FIG. 23 exemplifies the operation log record of the case ID=1. The operation details are the same as the operation details in the task details 2002 illustrated in FIG. 20. In this example, the past case DB 216 and the problem operation table 217 are provided, but the data may be stored in one DB or table, or in more DBs or tables.

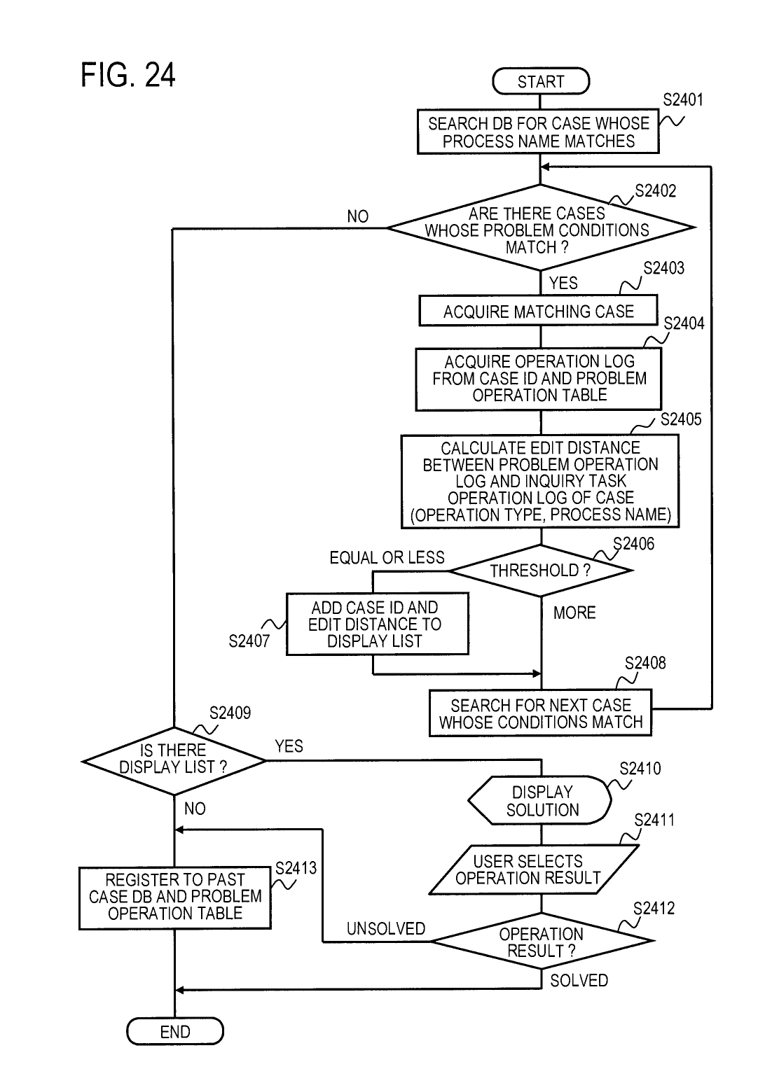

Next, the determination of the problem solution candidate by the management server 100 is described with reference to a flow chart of FIG. 24. The client problem solving program 211 executes the determination. The client problem solving program 211 searches the past case DB 216 for a case (entry) that matches with the process name acquired from the client computer 130 (S2401).

Specifically, as described above with reference to FIG. 6, the client problem solving program 211 acquires information indicating the problem generating task (operation log group) from the client computer 130 to identify a problem generating process. In the example of FIG. 6, the final process in the operation log group is determined as the problem generating process.

The client problem solving program 211 searches the past case DB 216 for an entry whose process name matches with the process name of the process. In this example, in entries in which the solution date/time is registered, an entry whose process name matches is searched for. Entries in which the solution date/time is not registered are unsolved entries.

When there is an entry whose process name matches in the past case DB 216 (S2402: YES), the client problem solving program 211 acquires the case from the past case DB 216 (S2403), and acquires (the operation log group formed of) the operation log record having the same case ID from the problem operation table 217 (S2404).

The client problem solving program 211 calculates an edit distance between the operation log group for which the inquiry is made by the client computer 130 as the problem generating task and the operation log group acquired in Step S2404 (S2405). The edit distance represents a similarity between two operation log groups. The method of calculating the edit distance is described later.

The client problem solving program 211 compares the above-mentioned calculated edit distance and a preset threshold (S2406). When the edit distance is more than the threshold (S2406: more), the client problem solving program 211 determines that the operation log groups are not similar. When the edit distance is equal to or less than the threshold (S2406: equal or less), the client problem solving program 211 determines that the operation log groups are similar.

When the operation log groups are similar (S2406: equal or less), the client problem solving program 211 adds the case ID and the edit distance to the display list (S2407), and proceeds to Step S2408. When the display list is not generated, the client problem solving program 211 generates the same and adds the entry.

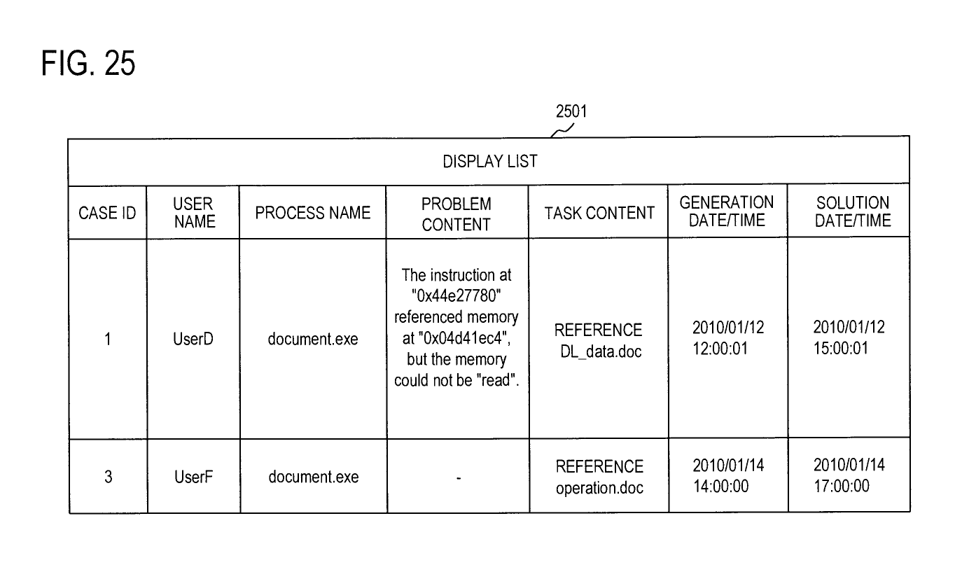

FIG. 25 illustrates an example of the display list 2501. The display list 2501 includes columns of case ID, user name, process name, problem content, task content, generation date/time, and solution date/time. Those columns are similar to the columns of the past case DB 216. In the example of FIG. 25, two entries are registered, which are the task (operation log group) for which the inquiry is made and a past case of similar registered task (registered operation log group).

When the operation log groups are not similar (S2406: more), the client problem solving program 211 searches the past case DB 216 for a next entry whose process name matches without adding an entry to the display list 2501 (S2408). Then, the client problem solving program 211 repeats Steps S2402 to S2408.

In Step S2402, when no entry whose process name matches exists or remains in the past case DB 216 (S2402: NO), the client problem solving program 211 determines whether or not there is a display list 2501 that has an entry to be displayed as a solution candidate (S2409).

When there is a display list 2501 (S2409: yes), the client problem solving program 211 transmits to the client computer 130 each entry of the display list 2501, operation log records of each entry, information on the edit distance of each entry, and information on an access destination for obtaining information for solving the problem of each entry.

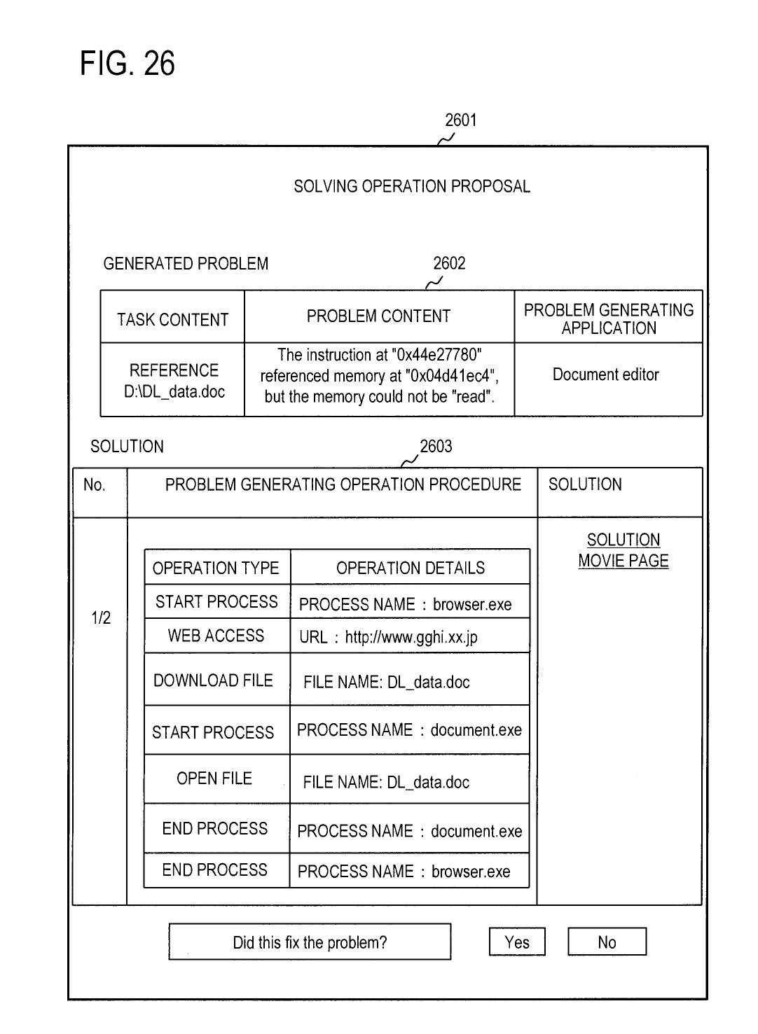

The client problem solving program 141 of the client computer 130 that has received those pieces of information causes the display device 135 to display the information indicating the solution candidate (S2410). FIG. 26 illustrates an example of a solution candidate display image 2601. This corresponds to the example of the display list 2501 of FIG. 25. As described above, the display list 2501 has two entries, but the solution candidate display image 2601 shows one of the two entries. The other entry is displayed when selected by the user.

The solution candidate display image 2601 includes a section of generated problem 2602 and a section of solution 2603. In the section of generated problem 2602, the task in which the problem has been generated, the problem content, and the like are described. The section of solution 2603 includes an operation log record of the operation log group in which the problem has been generated, that is, an operation procedure that is the cause of the problem, and a link to a solution movie that presents an operation for solving the problem. The solution movie data is stored, for example, in the secondary storage device 204.

When the user selects the link to the solution movie through the input device 136, the user can watch the movie on the display device 135. Typically, the solution movie shows the movement of the pointer on the screen of the display device 135 and description of the method of operating the input device 136. The operation for solving the problem may be presented by a method other than the movie. The method of specifically presenting the content of the solution to the problem may include, for example, using a still image, or using an image of only texts.

Typically, the client problem solving program 141 gives a priority of display to the solution candidate depending on the edit distance (similarity). For example, when only one solution candidate is displayed on a screen as in this example, the client problem solving program 141 displays in order from a solution candidate having high similarity (small edit distance).

Alternatively, the client problem solving program 141 may display a list of all solution candidates along with values indicating similarities (priorities) thereof (for example, integers indicating orders in order from highest similarity). The section of solution 2603 may be displayed when a link in the section of generated problem 2602 is selected.

Returning to the flow chart of FIG. 24, in Step S2411, the user uses the input device 136 to select whether or not the problem has been solved by any one of the solution candidates. Specifically, when the problem has been solved by any one of the solution candidates, the user selects “yes” in the solution candidate display image 2601. When the problem is not solved by any of the solution candidates, the user selects “no”.

When the problem has been solved, the client problem solving program 141 notifies the management server 100 of the result along with information indicating the solution. When the problem is not solved, the client problem solving program 141 notifies the management server 100 of the result.

The client problem solving program 211 in the management server 100 determines whether or not the problem has been solved based on the notification from the client computer 130 (S2412). When the problem has been solved (S2412: solved), this flow ends. When the problem is not solved (S2412: unsolved), the client problem solving program 211 gives a case ID to the current case in the past case DB 216 and stores information on the current case in the past case DB 216. This entry is an unsolved entry, and hence, the client problem solving program 211 does not register the solution date/time at this time.

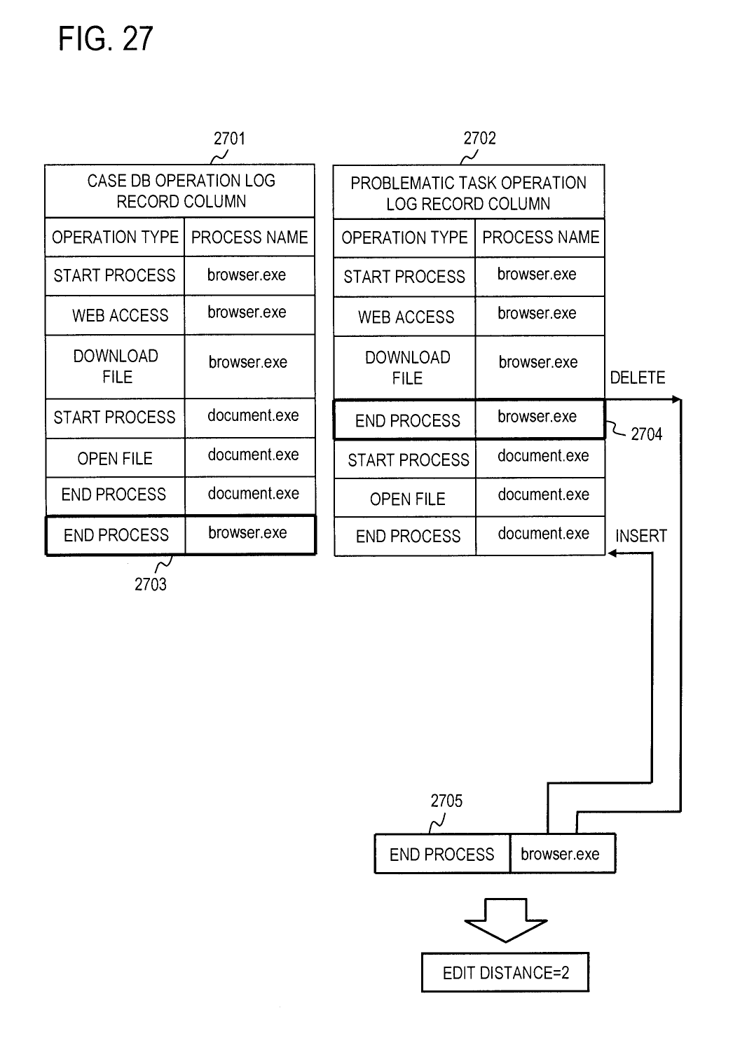

Next, the calculation of the similarity between the operation log groups (S2405) is described. As described above, in this example, the client problem solving program 211 determines the similarity between two operation log groups based on the edit distance between the operation log groups. FIG. 27 is a diagram illustrating an example of the calculation of the edit distance.

FIG. 27 illustrates two operation log groups 2701 and 2702 to be compared. The operation log group 2702 is an operation log group for which the client computer 130 inquires of the management server 100 as to a generated problem. The operation log group 2701 is one of the operation log groups registered in the past case DB 216, and is an operation log group which is selected in Step S2401 of the flow chart of FIG. 24 as the operation log group whose process name matches with the process name of the operation log group 2702 for which the inquiry has been made.

For the purpose of calculating the edit distance between the two operation log groups, the client problem solving program 211 regards each of the two operation log groups as a column of operation log records arrayed in chronological order of the operation date/time. In this example, each entry (operation log record) consists of the operation type and the process name. The configuration of (information included in) the entry is appropriately defined in design. The edit distance is expressed as the minimum number of insertions, deletions, and substitutions of entries required to match one column of the operation log records with the other column of the operation log records. The matched columns of the operation log records mean that the contents of (information included in) the operation log records (entries) and orders thereof match.

Comparing the operation log record column 2701 and the operation log record column 2702, an entry (operation log record) 2704 in the operation log record column 2702 does not exist in the operation log record column 2701. Further, an entry (operation log record) 2703 in the operation log record column 2701 does not exist in the operation log record column 2702.

Therefore, in order to match the operation log record column 2702 with the operation log record column 2701, the entry 2704 may be deleted from the operation log record column 2702, and an entry 2705 may be added to the end of the operation log record column 2702. In other words, one deletion and one insertion are required. Thus, the minimum number of operations required to match the two operation log groups 2701 and 2702 is two, and the edit distance between the operation log groups 2701 and 2702 is 2.

The client problem solving program 211 may use another value to express the similarity between the two operation log groups. For example, the similarity may be calculated by a longest common subsequence. For calculation of the similarity (for example, edit distance), any algorithm that is selected in accordance with design, such as dynamic programming, O(ND), O(NP), or Gestalt Approach may be used. The calculation of the similarity between two columns is a well known technology, and a further detailed description thereof is omitted.

As described above with reference to the flow chart of FIG. 24, a problem that is not solved is registered in the past case DB 216 as an unsolved problem (S2413). According to the embodiment of this invention, the operator at the help desk presents to the user a solution to the unsolved problem registered in the past case DB 216. Further, the solution is registered in the management server 100 in association with a corresponding entry in the past case DB 216. This way, the problem that cannot be solved by the help desk function of the management server 100 is solved, and the future probability of problems solved by the management server 100 may be increased.

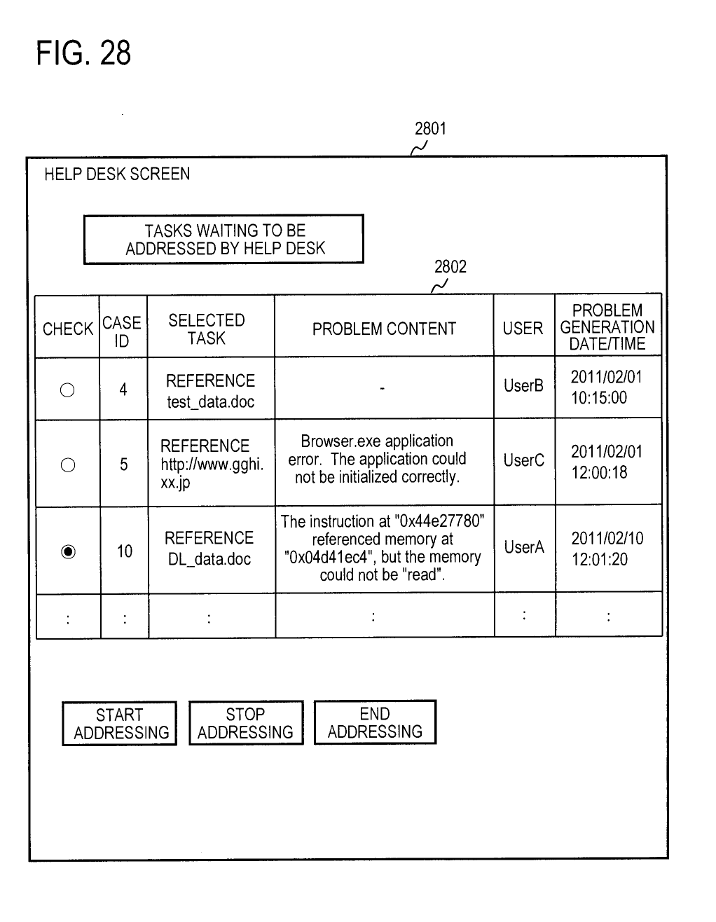

FIG. 28 illustrates an example of a help desk screen 2801 displayed on a computer of the operator. The operator may access the management server 100 from another computer or directly operate the management server 100 through the input device thereof. The screen of FIG. 28 shows a list 2802 of tasks waiting to be addressed by the help desk, which is a list of unsolved problems registered in the past case DB 216. In FIG. 28, three entries are exemplified. For example, the client problem solving program 211 creates this list from the past case DB 216.

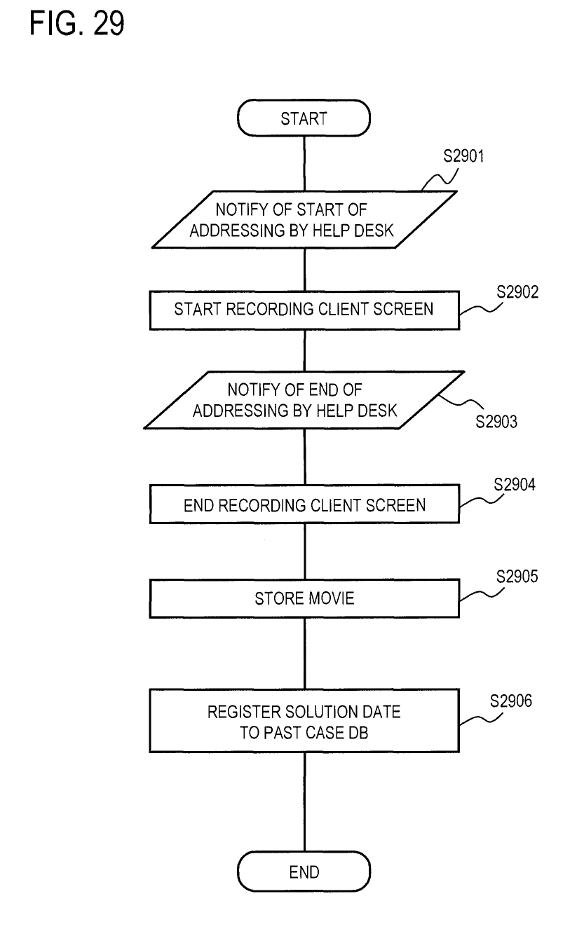

FIG. 29 is a flow chart illustrating a flow of presenting a solution by the operator and registering the solution. The flow chart of FIG. 29 is described with reference to the help desk screen 2801 of FIG. 28. The operator contacts the user by telephone, for example, and selects a problematic entry of the user from the list 2802.

In the example of FIG. 28, a case of UserA having the case ID of 10 is selected. The operator presses the button “start addressing” in the help desk screen 2801 and notifies the client computer 130 and the problem solving program 211 of the management server 100 of start of addressing the problem solving (S2901).

The operator uses the function of the problem solving program 211 of the management server 100 to remotely operate the client computer 130 from his own computer. The client problem solving program 211 records the changing screen of the display device 135 of the client computer 130 during the remote operation (S2902).

When the problem is solved by the remote operation of the client computer 130, the operator presses the button “end addressing” in the help desk screen 2801 and notifies the client computer 130 and the problem solving program 211 of the management server 100 of end of addressing the problem solving (S2903).

When the end notification is received, the client problem solving program 211 ends the recording of the client screen (S2904) and stores the recorded data in the secondary storage device 204 in association with the corresponding case (S2905). The client problem solving program 211 further searches the past case DB 216 for an entry having the case ID (in this example, ID=10) of the solved problem case and stores data in the problem solution date/time of the entry (S2906).

The management system may group the operation log records in a method that is different from the above-mentioned method. As an example, in the above-mentioned preferred configuration, the management system uses two types of group identifiers in the grouping of the operation log. The management system may use only one group identifier, or may use three or more group identifiers. As described above, it is preferred that different groups grouped by one or a plurality of group identifiers be integrated using the input and output information, but this may be omitted. The management system may perform the grouping in a different logon phase in the client computer 130 or in the operation log of a different user.

For the purpose of grouping the operation log groups, an attribute value that is different from the process ID or the context information may be used as the group identifier. For example, the operation log records are grouped by a window identifier (for example, an identifier called “window handle”). The window identifier may be obtained from, for example, the OS.

The window identifier identifies a window on a screen, and for example, different window identifiers are allocated to a plurality of child windows in a parent window of Multiple Document Interface (MDI), respectively. When the client computer 130 uses Tabbed Document Interface (TDI) and one window switchably displays a plurality of documents by tabs, different window identifiers are allocated to the tabs, respectively. In this manner, the term “window” is not limited to a single window and may include child windows and tabs in a window.

Alternatively, a thread ID may be used as the group identifier. In this manner, the operation log records may be grouped by an identifier of an object to be subjected to an operation, such as a process, window, or thread to be subjected to an operation.

As described above, the management server 100 has the help desk function for solving a problem in the client computer 130. In addition or instead, the management server 100 may perform, as management of the client computer, management of the user task by using the operation log in the client computer.

The management system puts, in the grouping of the above-mentioned operation log records, a series of associated operations in the operation log in the client computer, and information representing the group to the administrator. This way, the administrator may be effectively facilitated to grasp the user task.

Specifically, after grouping the operation log records and giving a name to the groups as described above, the operation log grouping program 208 transmits the processing result to the management console 110. The operation log grouping program 208 uses the management console communication program 210 to transmit the processing result to the management console 110 through the network I/F 206 and the network 120.

The management console 110 receives the above-mentioned processing result through the network I/F 117, and stores the received processing result in the storage device 112. The web browser 103 displays the received processing result on the display device 115. For example, the management console 110 causes the grouped operation log records to be displayed through an image as illustrated in FIG. 20.

In FIG. 20, the task list 2001 allows the administrator to check tasks performed by the managed user. Each of the displayed tasks corresponds to the integrated or non-integrated group. Each entry includes fields of task start date/time, task end date/time, machine name (client computer name), user name, and task name.

The column of operation details shows a specific target and a content of the operation. The data type displayed in the operation details is defined in the definition information in advance, and the operation log grouping program 208 may acquire the data from the operation log DB 212. The task details 2002 allow the administrator to check all operations included in the selected task.

As described above, it is preferred that the operation log management system give a task name to the group which is obtained by grouping the operation log records and expected to be included in the same task, and display the name as information representing the group, but another value may alternatively be displayed. It is preferred that the operation log management system display the task list and further display details of the task selected from the list. However, the task list and the task details may be displayed simultaneously, or only one of the task list and the task details may be generated for display.

In the grouping of the operation log records, for example, the operation log grouping program 208 groups operations performed by the same login user in the same client computer. This way, a series of operations of the same task performed by one user may be effectively and adequately expected.

The operation log grouping program 208 may group the operation log records in a plurality of client computers. The operation log grouping program 208 may group not only the operation log records performed by the same user in the plurality of client computers, but also the operation log records performed by a plurality of users in the plurality of client computers.

The operation log grouping program 208 may group the operation log records from logon to logoff, to thereby identify and display the user task by efficient processing. The operation log grouping program 208 may group the operation log records in a plurality of time periods from logon to logoff, to thereby identify and display the user task.

The operation log grouping program 208 may group the operation log records of a plurality of client computers, which are a selected part of the client computers from which the operation log is acquired, or may group the operation log records of a plurality of users, which are a part of a plurality of users for whom the operation log is acquired.

The operation log grouping program 208 may use, in order to associate different groups of client computers 130 by the input and output information, hash values of input and output data, for example. Alternatively, the operation log grouping program 208 may use, in order to identify data communicated between the client computers 130, sockets at the transmission source and the transmission destination used in the communication. A socket is a combination of a protocol (TCP or UDP) and a port number. IP addresses, protocol identification information, and port numbers of the transmission source and the transmission destination of the data are included.

Hereinabove, an embodiment of this invention has been described, but it is not intended to limit this invention to the above-mentioned embodiment. A person having ordinary skill in the art may easily change, add, or convert elements of the above-mentioned embodiment within the scope of this invention.

Some or all of the above-mentioned configurations and functions may be realized by hardware obtained by designing, for example, an integrated circuit. Information realizing the functions, such as programs, tables, and files, may be stored in a storage device such as a non-volatile semiconductor memory, a hard disk drive, or a solid state drive (SSD), or a non-transitory computer-readable data storage medium such as an IC card, an SD card, or a DVD.

The management system may include, in addition to the above-mentioned management server and management console, a plurality of management servers for collecting operation logs in a plurality of client computers. As an example, a central management server collects the operation logs from the plurality of other management servers and performs grouping of operation log records and generation of data for displaying user tasks.

What is claimed is:

1. A computer system, comprising:
a client computer; and
a management system,
wherein:
the client computer acquires an operation log of operations in the client computer;
the management system acquires a first operation log group consisting of a plurality of operation log records including an operation log record of an operation in which a first problem is generated from the operation log;
the management system stores in advance problem examples associated with operation log groups each consisting of a plurality of operation log records and with solutions;
the management system searches the operation log groups associated with the stored problem examples for an operation log group which is determined to be similar to the first operation log group based on the plurality of operation log records of the first operation log group; and
the management system determines a solution to one of the problem examples that is associated with the operation log group determined to be similar to the first operation log group, as a solution candidate to the first problem.

2. A computer system according to claim 1,
wherein each of operation log records acquired from the operation log in the client computer includes a type of an operation and a group identifier for identifying a group to which the operation belongs, and
wherein the management system groups the operation log records acquired from the operation log in the client computer into a plurality of operation log groups including the first operation log group based on the group identifiers.

3. A computer system according to claim 2, wherein each of group identifiers of at least a part of the operation log records acquired from the operation log include at least a part of a URL of an access destination.

4. A computer system according to claim 3, wherein the management system groups the operation log records acquired from the operation log into the plurality of operation log groups including the first operation log group based on a plurality of types of group identifiers included in each of the operation log records acquired from the operation log.

5. A computer system according to claim 4,
wherein the management system selects, in the operation log groups associated with the stored problem examples, one or more operation log groups of which the last operation log record has a process type that is the same as a process type of the last operation log record in the first operation log group,
wherein the management system calculates a similarity between each of the selected one or more operation log groups and the first operation log group, based on an operation of each of the operation log records and an operation order in each of the selected one or more operation log groups, and
wherein the management system determines a solution to a problem example associated with an operation log group for which the calculated similarity satisfies a predetermined condition, as a solution candidate for the first problem.

6. A computer system according to claim 5, wherein the management system registers the first operation log group and the first problem for which a similar operation log group is not found in the operation log groups associated with the stored problem examples, as an unsolved case.

7. A computer system according to claim 6,
wherein the client computer selects the first operation log group from the plurality of operation log groups in response to a user input, and transmits information indicating the first operation log group to the management system,
wherein the management system transmits information indicating the solution candidate to the client computer, and
wherein the client computer displays the information indicating the solution candidate.

8. A computer system according to claim 7, wherein, in the grouping of the plurality of operation log groups, the management system integrates different operation log groups which are grouped by the group identifiers and include an operation log record with output information and another operation log record whose input information matches with the output information, respectively, to thereby generate an operation log group.

9. A method of managing a client computer by a management system, comprising:
acquiring, by the management system, a first operation log group consisting of a plurality of operation log records including an operation log record of an operation in which a first problem is generated in the client computer;
storing in advance, by the management system, problem examples associated with operation log groups each consisting of a plurality of operation log records and with solutions;
searching, by the management system, the operation log groups associated with the stored problem examples for an operation log group which is determined to be similar to the first operation log group based on the plurality of operation log records of the first operation log group; and
determining, by the management system, a solution to one of the problem examples that is associated with the operation log group determined to be similar to the first operation log group, as a solution candidate to the first problem.

10. A method of managing a client computer according to claim 9,
wherein each of operation log records acquired from the operation log in the client computer includes a type of an operation and a group identifier for identifying a group to which the operation belongs, and
wherein the method further comprises grouping, by the management system, the operation log records acquired from the operation log in the client computer into a plurality of operation log groups including the first operation log group based on the group identifiers.

11. A method of managing a client computer according to claim 10, wherein the grouping of the plurality of operation log groups comprises integrating, by the management system, different operation log groups which are grouped by the group identifiers and include an operation log record with output information and another operation log record whose input information matches with the output information, respectively, to thereby generate an operation log group.

12. A method of managing a client computer according to claim 10, wherein the grouping, by the management system, the operation log records acquired from the operation log into the plurality of operation log groups including the first operation log group is performed based on a plurality of types of group identifiers included in each of the operation log records acquired from the operation log.

13. A method of managing a client computer according to claim 9, further comprising:
selecting, by the management system, in the operation log groups associated with the stored problem examples, one or more operation log groups of which the last operation log record has a process type that is the same as a process type of the last operation log record in the first operation log group;
calculating, by the management system, a similarity between each of the selected one or more operation log groups and the first operation log group; and
determining, by the management system, a solution to a problem example associated with an operation log group for which the calculated similarity satisfies a predetermined condition, as a solution candidate for the first problem.

14. A non-transitory computer-readable storage medium including program code, the program code controlling a management computer system to execute a method of managing a user operation log in a client computer, the method comprising:
storing a plurality of operation log records acquired from an operation log in the client computer in a storage device,
each of the plurality of operation log records including a type of an operation and a group identifier for identifying a group to which the operation belongs,
each of group identifiers of at least a part of the plurality of operation log records including at least a part of a URL of an access destination;
grouping the plurality of operation log records into a plurality of groups based on the group identifiers; and
displaying information representing each of the plurality of groups.

15. A non-transitory computer-readable storage medium according to claim 14, wherein the grouping into the plurality of groups comprises integrating different operation log groups which are grouped by the group identifiers and include an operation log record with output information and another operation log record whose input information matches with the output information, respectively, to thereby generate an operation log group.
